(19) United States
(12) Patent Application Publication
(10) Pub. No.: US 2025/0377731 A1
(43) Pub. Date: Dec. 11, 2025

(54) ELECTRONIC DEVICE AND METHOD FOR GESTURE RECOGNITION

(71) Applicant: SAMSUNG ELECTRONICS CO., LTD., Suwon-si (KR)

(72) Inventors: Jinyoup AHN, Suwon-si (KR); Cheolo Kim, Suwon-si (KR); Wonsuk Chung, Suwon-si (KR); Yongsang Cho, Suwon-si (KR)

(73) Assignee: SAMSUNG ELECTRONICS CO., LTD., Suwon-si (KR)

(21) Appl. No.: 19/093,968

(22) Filed: Mar. 28, 2025

Related U.S. Application Data
(63) Continuation of application No. PCT/KR2025/003743, filed on Mar. 24, 2025.

(30) Foreign Application Priority Data
Jun. 11, 2024 (KR) 10-2024-0075929
Jun. 28, 2024 (KR) 10-2024-0085842
Jul. 8, 2024 (KR) 10-2024-0089961

(51) Int. Cl. G06F 3/01; G06F 3/04842; G06F 3/04847

(52) U.S. Cl. CPC G06F 3/017; G06F 3/04842; G06F 3/04847

(57) ABSTRACT

According to an embodiment, a method performed by an electronic device includes displaying, via a display of the electronic device, a screen for guiding performance of a reference gesture via a part of body of a user on which a wearable device connected to the electronic device is worn. The method includes, while the screen is displayed, identifying that at least one value related to a gesture of the user, obtained via the wearable device, is out of a threshold range related to the reference gesture. The method includes, based on identifying that the at least one value related to the gesture of the user is out of the threshold range, displaying, via the display, a visual object for guiding to change the threshold range. The method includes, according to an input related to the visual object, changing the threshold range.

### CROSS-REFERENCE TO RELATED APPLICATION(S)

This application is a continuation application, claiming priority under 35 U.S.C. § 365 (c), of an International application No. PCT/KR2025/003743, filed on Mar. 24, 2025, which is based on and claims the benefit of a Korean patent application number 10-2024-0075929, filed on Jun. 11, 2024, in the Korean Intellectual Property Office, a Korean patent application number 10-2024-0085842, filed on Jun. 28, 2024, in the Korean Intellectual Property Office, and a Korean patent application number 10-2024-0089961, filed on Jul. 8, 2024, in the Korean Intellectual Property Office, the disclosure of each of which is incorporated by reference herein in its entirety.

### BACKGROUND

### 1. Field

The disclosure relates to an electronic device and a method for gesture recognition.

### 2. Description of Related Art

Various services may be provided through a wearable device. The wearable device may be worn on a part of a user's body to operate. While being worn on a part of the user's body, the wearable device may identify biometric information of the user and provide a service based on the user's biometric information. An electronic device connected with the wearable device may control the wearable device.

The above-described information may be provided as a related art for the purpose of helping to understand the present disclosure. No claim or determination is raised as to whether any of the above-described information may be applied as a prior art related to the present disclosure.

### SUMMARY

According to an embodiment, an electronic device may comprise a display, communication circuitry, memory storing instructions, comprising one or more storage media, and at least one processor comprising processing circuitry. The instructions, when executed by the at least one processor individually or collectively, may cause the electronic device to display, via the display, a screen for guiding performance of a reference gesture via a part of body of a user on which a wearable device connected to the electronic device is worn. The instructions, when executed by the at least one processor individually or collectively, may cause the electronic device to, while the screen is displayed, identify that at least one value related to a gesture of the user, obtained via the wearable device, is out of a threshold range related to the reference gesture. The instructions, when executed by the at least one processor individually or collectively, may cause the electronic device to, based on identifying that the at least one value related to the gesture of the user is out of the threshold range, display, via the display, a visual object for guiding to change the threshold range. The instructions, when executed by the at least one processor individually or collectively, may cause the electronic device to, according to an input related to the visual object, change the threshold range.

According to an embodiment, a method performed by an electronic device may comprise displaying, via a display of the electronic device, a screen for guiding performance of a reference gesture via a part of body of a user on which a wearable device connected to the electronic device is worn. The method may comprise, while the screen is displayed, identifying that at least one value related to a gesture of the user, obtained via the wearable device, is out of a threshold range related to the reference gesture. The method may comprise, based on identifying that the at least one value related to the gesture of the user is out of the threshold range, displaying, via the display, a visual object for guiding to change the threshold range. The method may comprise, according to an input related to the visual object, changing the threshold range.

According to an embodiment, a non-transitory computer readable storage medium may store one or more programs. The one or more programs may include instructions which, when executed by at least one processor of an electronic device with a display and communication circuitry, cause the electronic device to display, via the display, a screen for guiding performance of a reference gesture via a part of body of a user on which a wearable device connected to the electronic device is worn. The one or more programs may include instructions which, when executed by the at least one processor, cause the electronic device to, while the screen is displayed, identify that at least one value related to a gesture of the user, obtained via the wearable device, is out of a threshold range related to the reference gesture. The one or more programs may include instructions which, when executed by the at least one processor, cause the electronic device to, based on identifying that the at least one value related to the gesture of the user is out of the threshold range, display, via the display, a visual object for guiding to change the threshold range. The one or more programs may include instructions which, when executed by the at least one processor, cause the electronic device to, according to an input related to the visual object, change the threshold range.

According to an embodiment, a smart ring device may comprise at least one sensor for identifying movement of the smart ring device, communication circuitry, memory storing instructions, comprising one or more storage media, and at least one processor comprising processing circuitry. The instructions, when executed by the at least one processor individually or collectively, may cause the smart ring device to obtain, using the at least one sensor, first data related to movement of a part of a body of a user on which the smart ring device is worn in a first time interval. The instructions, when executed by the at least one processor individually or collectively, may cause the smart ring device to identify a second time interval related to at least one value greater than a threshold value among values identified based on the first data in the first time interval. The instructions, when executed by the at least one processor individually or collectively, may cause the smart ring device to identify second data corresponding to the second time interval of the first data. The instructions, when executed by the at least one processor individually or collectively, may cause the smart ring device to set one or more feature points identified based on the second data as an input of a model for identifying a gesture of the user. The instructions, when executed by the at least one processor individually or collectively, may cause the smart ring device to determine, based on an output of the model, a gesture corresponding to the movement of the part of the body, among a plurality of gestures. The instructions, when executed by the at least one processor individually or collectively, may cause the smart ring device to transmit, via the communication circuitry, information indicating the determined gesture to an electronic device connected with the smart ring device.

According to an embodiment, a method performed by a smart ring device may comprise obtaining, using at least one sensor of the smart ring device, first data related to movement of a part of a body of a user on which the smart ring device is worn in a first time interval. The method may comprise identifying a second time interval related to at least one value greater than a threshold value among values identified based on the first data in the first time interval. The method may comprise identifying second data corresponding to the second time interval of the first data. The method may comprise setting one or more feature points identified based on the second data as an input of a model for identifying a gesture of the user. The method may comprise determining, based on an output of the model, a gesture corresponding to the movement of the part of the body, among a plurality of gestures. The method may comprise transmitting, via a communication circuitry of the smart ring device, information indicating the determined gesture to an electronic device connected with the smart ring device.

According to an embodiment, a non-transitory computer readable storage medium may store one or more programs. The one or more programs may include instructions which, when executed by at least one processor of a smart ring device with at least one sensor and communication circuitry, cause the electronic device to obtain, using the at least one sensor, first data related to movement of a part of a body of a user on which the smart ring device is worn in a first time interval. The one or more programs may include instructions which, when executed by the at least one processor, cause the electronic device to identify a second time interval related to at least one value greater than a threshold value among values identified based on the first data in the first time interval. The one or more programs may include instructions which, when executed by the at least one processor, cause the electronic device to identify second data corresponding to the second time interval of the first data. The one or more programs may include instructions which, when executed by the at least one processor, cause the electronic device to set one or more feature points identified based on the second data as an input of a model for identifying a gesture of the user. The one or more programs may include instructions which, when executed by the at least one processor, cause the electronic device to determine, based on an output of the model, a gesture corresponding to the movement of the part of the body, among a plurality of gestures. The one or more programs may include instructions which, when executed by the at least one processor, cause the electronic device to transmit, via the communication circuitry, information indicating the determined gesture to an electronic device connected with the smart ring device.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram of an electronic device in a network environment according to an embodiment.

FIGS. 2A and 2B respectively illustrate front and rear perspective views of an exemplary electronic device according to an embodiment;

FIG. 3 illustrates an exploded perspective view of an exemplary electronic device according to an embodiment;

FIG. 4 illustrates a perspective view of an exemplary wearable device according to an embodiment;

FIG. 5A illustrates an example of simplified block diagrams of an electronic device and a wearable device;

FIG. 5B is an example of a partial cross-sectional view of a wearable device according to an embodiment;

FIG. 6 illustrates an example of an operation of a wearable device for identifying a user's gesture according to an embodiment;

FIG. 7 illustrates an example of data obtained through an acceleration sensor according to an embodiment;

FIG. 8 illustrates an example of a preprocessing operation according to an embodiment;

FIG. 9 illustrates an example of a signal segmentation operation according to an embodiment;

FIGS. 10A and 10B illustrate an example of a feature point extraction operation according to an embodiment;

FIG. 11 illustrates an example of a classification operation according to an embodiment;

FIGS. 12A and 12B illustrate an example of an operation of an electronic device and a wearable device for changing sensitivity of the wearable device, according to an embodiment;

FIG. 13 illustrates an example of a screen for changing sensitivity of a wearable device according to an embodiment;

FIG. 14 illustrates an example of gestures identified through a smart ring device according to an embodiment;

FIG. 15 illustrates an example of gestures identified through a smart watch device according to an embodiment; and

FIG. 16 illustrates an example of gestures identified through a true wireless stereo (TWS) device according to an embodiment.

### DETAILED DESCRIPTION

Hereinafter, embodiments of the present disclosure will be described in detail with reference to the drawings so that those of ordinary skill in the art to which the present disclosure pertains may implement them. However, the present disclosure may be implemented in various different forms and is not limited to the embodiments described herein. In the description of the drawings, the same or similar reference numerals may be used for the same or similar components. In addition, in the drawings and related descriptions, well-known functions and configurations may be omitted for clarity and conciseness.

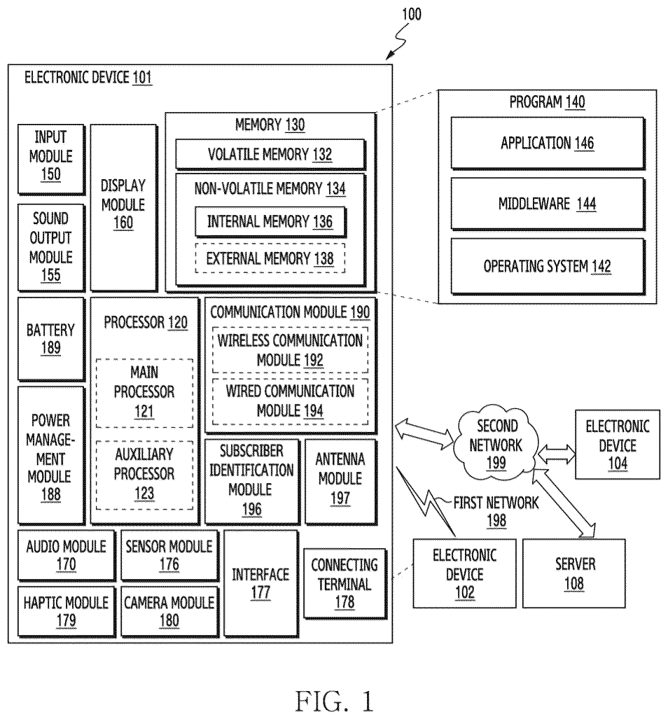

FIG. 1 is a block diagram of an electronic device in a network environment according to an embodiment.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

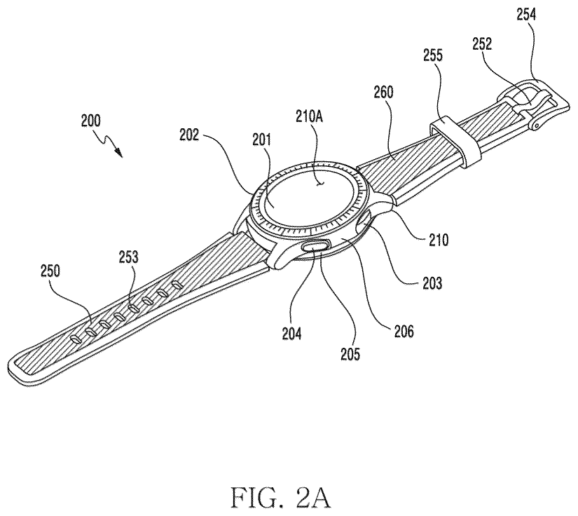

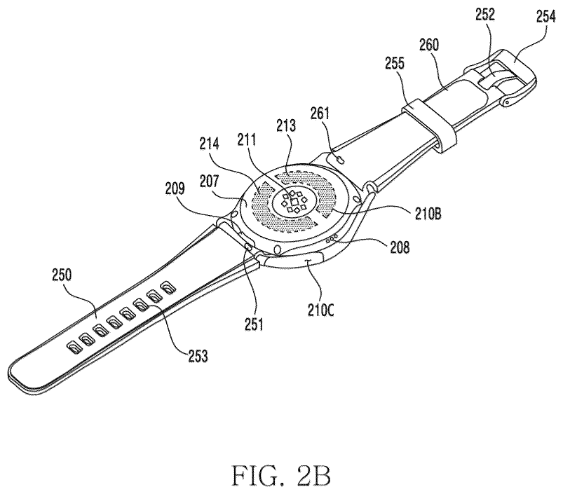

FIGS. 2A and 2B respectively illustrate front and rear perspective views of an exemplary electronic device according to an embodiment.

Referring to FIGS. 2A and 2B, an electronic device 200 (e.g., the electronic device 101 of FIG. 1) according to an embodiment may include a housing 210 that includes a first surface (or front surface) 210A, a second surface (or rear surface) 210B, and a side surface 210C surrounding a space between the first surface 210A and the second surface 210B, and coupling members 250 and 260, connected to at least a portion of the housing 210, configured to detachably couple the electronic device 200 to a body part (e.g., wrist or ankle) of a user. In another embodiment, the housing may also refer to a structure forming a portion of the first surface 210A, the second surface 210B, and the side surface 210C of FIGS. 2A and 2B. According to an embodiment, at least a portion of the first surface 210A may be formed by a substantially transparent front plate 201 (e.g., glass plate or polymer plate including various coating layers). The second surface 210B may be formed by a substantially opaque rear plate 207. For example, the rear plate 207 may be formed by a coated or colored glass, ceramic, polymer, metal (e.g., aluminum, stainless steel (STS), or magnesium), or a combination of at least two of the above materials. The side surface 210C may be coupled to the front plate 201 and the rear plate 207 and may be formed by a side bezel structure (or side member) 206 including metal and/or polymer. In some embodiments, the rear plate 207 and the side bezel structure 206 may be integrally formed and include the same material (e.g., a metallic material such as aluminum). The coupling member 250 and 260 may be formed of various materials and shapes. By a combination of at least two of woven fabric, leather, rubber, urethane, metal, ceramic, or the above materials, an integral and multiple unit links may be formed to be movable relative to each other.

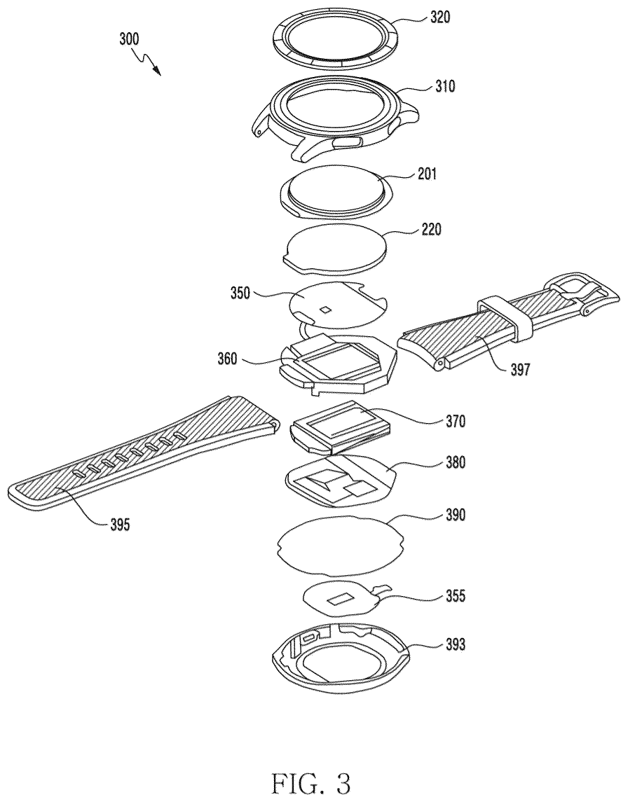

According to an embodiment, the electronic device 200 may include at least one of a display 220 (referring to FIG. 3), audio modules 205 and 208, a sensor module 211, key input devices 202, 203, and 204, and a connector hole 209. In some embodiments, the electronic device 200 may omit one or more of said components (e.g., the key input devices 202, 203, and 204, the connector hole 209, or the sensor module 211) or may additionally include another component.

For example, the display 220 may be visually exposed through a significant portion of the front plate 201. A shape of the display 220 may be a shape corresponding to a shape of the front plate 201, and may be various shapes such as a circle, an oval, or a polygon. The display 220 may be coupled to or disposed adjacent to a touch sensing circuit, a pressure sensor capable of measuring touch strength (pressure), and/or a fingerprint sensor.

The audio modules 205 and 208 may include a microphone hole 205 and a speaker hole 208. In the microphone hole 205, a microphone for obtaining an external sound may be disposed therein, and in some embodiments, a plurality of microphones may be disposed to detect a direction of the sound. The speaker hole 208 may be used as an external speaker and a call receiver. In some embodiments, the speaker hole 208 and the microphone hole 205 may be implemented as one hole, or a speaker may be included without the speaker hole 208 (e.g., a piezo speaker).

The sensor module 211 may generate an electrical signal or a data value corresponding to an operating state inside the electronic device 200 or an external environmental state. For example, the sensor module 211 may include a biometric sensor module 211 (e.g., an HRM sensor) disposed on the second surface 210B of the housing 210. The electronic device 200 may further include at least one of sensor modules not illustrated, such as a gesture sensor, a gyro sensor, a barometric pressure sensor, a magnetic sensor, an acceleration sensor, a grip sensor, a color sensor, an infrared sensor, a biometric sensor, a temperature sensor, a humidity sensor, or a light sensor.

The sensor module 211 may include electrode regions 213 and 214 forming a portion of a surface of the electronic device 200 and a biometric signal detection circuit electrically connected to the electrode regions 213 and 214. For example, the electrode regions 213 and 214 may include a first electrode region 213 and a second electrode region 214 disposed on the second surface 210B of the housing 210. The sensor module 211 may be configured such that the electrode regions 213 and 214 obtain an electrical signal from a part of the user's body, and the biometric signal detection circuit detects the user's biometric information based on the electrical signal.

The key input devices 202, 203, and 204 may include a wheel key 202 disposed on the first surface 210A of the housing 210 and rotatable in at least one direction, and/or side key buttons 203 and 204 disposed on the side surface 210C of the housing 210. The wheel key may have a shape corresponding to a shape of the front plate 201. In another embodiment, the electronic device 200 may not include some or all of key input devices 202, 203, and 204 described above, and the key input devices 202, 203, and 204 that are not included may be implemented in another form, such as a soft key, on the display 220. The connector hole 209 may include a connector (e.g., a USB connector) for transmitting and receiving power and/or data with an external electronic device and another connector hole for transmitting and receiving audio signals with an external electronic device. The connector hole 209 may include another connector hole capable of accommodating a connector (e.g., a USB connector) for transmitting and receiving power and/or data with an external electronic device and accommodating a connector for transmitting and receiving an audio signal with the external electronic device. For example, the electronic device 200 may further include a connector cover (not illustrated) covering at least a portion of the connector hole 209 and blocking the inflow of external foreign substances into the connector hole.

The coupling members 250 and 260 may be detachably coupled to at least a partial region of the housing 210 by using locking members 251 and 261. The coupling members 250 and 260 may include one or more of a fixing member 252, a fixing member fastening hole 253, a band guide member 254, and a band fixing ring 255.

The fixing member 252 may be configured to fix the housing 210 and the coupling members 250 and 260 to a part (e.g., wrist or ankle) of the user's body. The fixing member fastening hole 253 may fix the housing 210 and the coupling members 250 and 260 to a part of the user's body by corresponding to the fixing member 252. The band guide member 254 may be configured to limit a movement range of the fixing member 252 when the fixing member 252 is fastened to the fixing member fastening hole 253, such that the coupling members 250 and 260 are coupled in close contact with a part of the user's body. The band fixing ring 255 may limit a movement range of the coupling members 250 and 260 in a state in which the fixing member 252 and the fixing member fastening hole 253 are fastened.

FIG. 3 illustrates an exploded perspective view of an electronic device according to an embodiment.

Referring to FIG. 3, an electronic device 300 (e.g., the electronic device 101 of FIG. 1 or the electronic device 200 of FIG. 2A to 2B) may include a side bezel structure 310, a wheel key 320 (e.g., the wheel key 202 of FIG. 2A), a front plate 201, a display 220, a first antenna 350, a second antenna 355, a support member 360, a battery 370, a printed circuit board 380, a sealing member 390, a rear plate 393 (e.g., the rear plate 207 of FIG. 2B), and coupling members 395 and 397 (e.g., the coupling members 250 and 260 of FIG. 2B). At least one of components of the electronic device 300 may be the same as or similar to at least one of the components of the electronic device 200 of FIG. 1 or 2A to 2B, and a redundant description will be omitted below. The support member 360 may be disposed inside the electronic device 300 to be connected to the side bezel structure 310, or may be integrally formed with the side bezel structure 310. For example, the support member 360 may be formed of a metal material and/or a non-metal material (e.g., polymer). In the support member 360, the display 220 may be coupled to a surface and the printed circuit board 380 may be coupled to another surface. A processor, memory, and/or an interface may be mounted on the printed circuit board 380. For example, the processor may include one or more of a central processing unit, a graphic processing unit (GPU), an application processor, a sensor processor, or a communication processor.

For example, the memory may include a volatile memory or a nonvolatile memory. For example, an interface may include a high definition multimedia interface (HDMI), a universal serial bus (USB), an SD card interface, and/or an audio interface. For example, the interface may electrically or physically connect the electronic device 300 to an external electronic device, and may include a USB connector, an SD card/MMC connector, or an audio connector.

For example, the battery 370, which is a device for supplying power to at least one component of the electronic device 300, may include a non-rechargeable primary battery, a rechargeable secondary battery, or a fuel cell. For example, at least a portion of the battery 370 may be disposed on substantially the same plane as the printed circuit board 380. The battery 370 may be integrally disposed within the electronic device 200 or may be detachably disposed with the electronic device 200.

The first antenna 350 may be disposed between the display 220 and the support member 360. For example, the first antenna 350 may include a near field communication (NFC) antenna, a wireless charging antenna, and/or a magnetic secure transmission (MST) antenna. For example, the first antenna 350 may perform short-range communication with an external device, wirelessly transmit and receive power required for charging, and transmit a self-based signal including short-range communication signals or payment data. In another embodiment, an antenna structure may be formed by a portion or a combination of the side bezel structure 310 and/or the support member 360.

The second antenna 355 may be disposed between the printed circuit board 380 and the rear plate 393. For example, the second antenna 355 may include a near field communication (NFC) antenna, a wireless charging antenna, and/or a magnetic secure transmission (MST) antenna. For example, the second antenna 355 may perform short-range communication with an external device, wirelessly transmit and receive power required for charging, and transmit a self-based signal including short-range communication signals or payment data. In another embodiment, an antenna structure may be formed by a portion or a combination of the side bezel structure 310 and/or the rear plate 393.

The sealing member 390 may be disposed between the side bezel structure 310 and the rear plate 393. The sealing member 390 may be configured to block moisture and foreign substances flowing into a space surrounded by the side bezel structure 310 and the rear plate 393 from the outside.

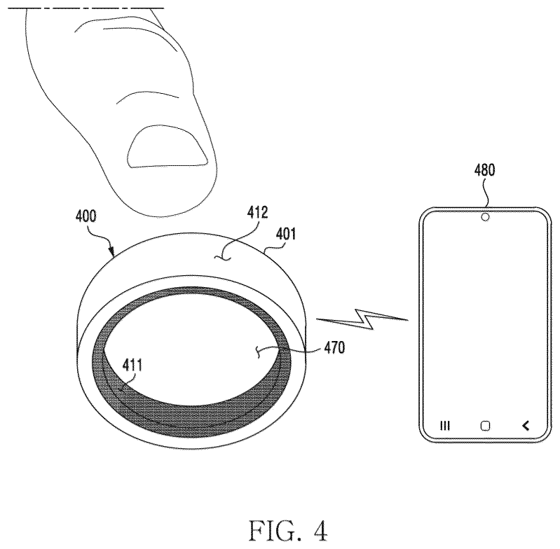

FIG. 4 illustrates a perspective view of an exemplary wearable device according to an embodiment.

Referring to FIG. 4, a wearable device 400 (e.g., the electronic device 101 of FIG. 1) may include a housing 401 including a first surface 411 facing a part (e.g., a finger) of a user's body and a second surface 412 opposite to the first surface 411. For example, the wearable device 400 may include a ring-shaped housing 401. As an example, the wearable device 400 may be configured in a ring shape. The wearable device 400 may be referred to as a smart ring device.

An electronic device 480 may be connected to and operate in conjunction with the wearable device 400. The electronic device 480 may provide a function for changing setting information on the wearable device 400. The electronic device 480 may include a foldable device, a tablet, and a personal computer (PC), but the disclosure is not limited thereto.

According to an embodiment, the wearable device 400 may be worn on a part of the user's body (e.g., a finger). For example, the wearable device 400 may be fastened to a part of a user's body. For example, the wearable device 400 may be detachable from a part of the user's body. For example, in order to be worn on a part of the user's body, the wearable device 400 may have a shape corresponding to a part of the user's body.

For example, the wearable device 400 may be in contact with a part of the user's body, by being worn by the user. For example, the wearable device 400 may be configured to obtain information on the user through a part of the user's body, by being worn by the user. As an example, the information on the user may include the user's biometric information. However, it is not limited thereto. For example, the wearable device 400 may provide information on a user through the wearable device 400 and/or an external electronic device connected to the wearable device 400. However, it is not limited thereto.

According to an embodiment, at least a portion of the first surface 411 may be in contact with a part of the user's body when the wearable device 400 is worn by the user. For example, the first surface 411 may surround a part of the user's body on which the wearable device 400 is worn. For example, the first surface 411 may cover a part of the user's body on which the wearable device 400 is worn. For example, the first surface 411 may be configured to pressurize a part of the user's body when the wearable device 400 is worn by the user such that the wearable device 400 is fastened to a part of the body. For example, the first surface 411 may be deformable by a part of the user's body. For example, the wearable device 400 may provide, through the first surface 411, information on the user, based on haptic technology.

For example, the second surface 412 may form an exterior of the wearable device 400 together with the first surface 411. For example, the second surface 412 may form a ring-shaped housing 401 together with the first surface 411. For example, the second surface 412 may be a surface spaced apart from a part of the user's body when the wearable device 400 is worn by the user. For example, the first surface 411 may be referred to as an inner circumference surface of the housing 401. The second surface 412 opposite to the first surface 411 may be referred to as an outer circumference surface of the housing 401.

For example, the second surface 412 may be exposed to the outside in a state that the wearable device 400 is worn by the user. The second surface 412 may be composed of at least one of titanium, stainless steel, and ceramic. The second surface 412 may be composed of a material for protecting against external impact and/or scratches. According to an embodiment, the second surface 412 may be coated with an additional material to protect the color of the wearable device 400 and/or the exterior of the wearable device 400.

For example, the first surface 411 may be composed of a material identical to and/or similar to the second surface 412. According to an embodiment, at least a portion of the first surface 411 may be composed of at least one of a molding material for obtaining data, a transparent plastic, and/or glass. According to an embodiment, at least a portion of the first surface 411 may be composed of a metal for identifying a bio-signal.

According to an embodiment, the wearable device 400 may further include a hole 470 formed by the first surface 411 to pass a part of the user's body when the wearable device 400 is worn by the user. For example, when the wearable device 400 is worn by the user, the hole 470 may be penetrated by a part of the user's body. The wearable device 400 may be configured to be fastened to a part of the user's body when the user wears the wearable device 400 by including the hole 470 configured to pass through a part of the user's body.

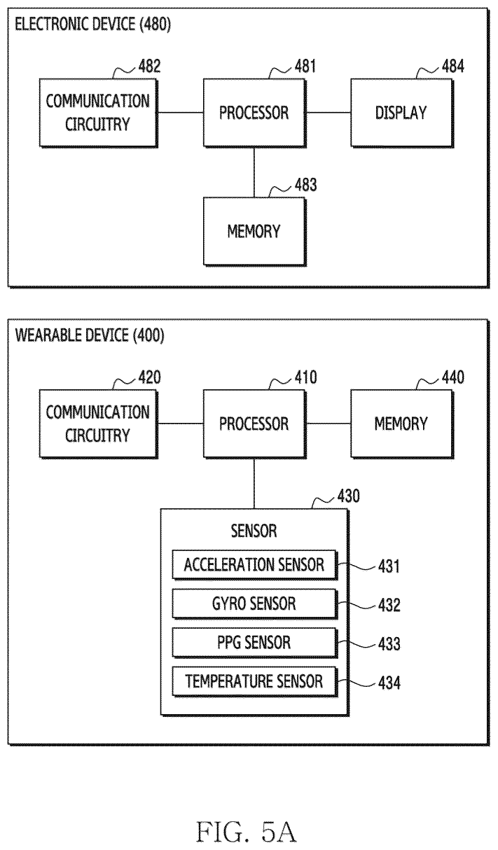

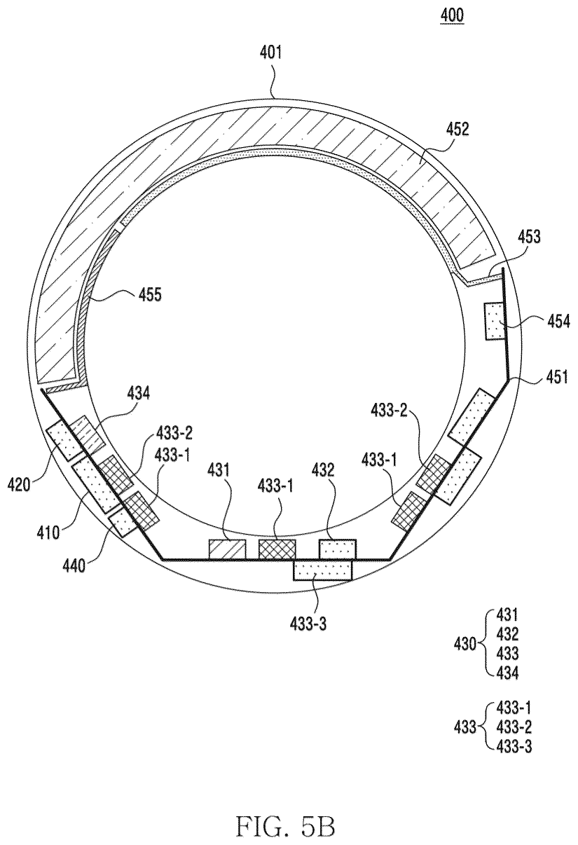

According to an embodiment, the wearable device 400 may further include one or more components between the first surface 411 and the second surface 412. For example, the wearable device 400 may include communication circuit, one or more sensors, and/or a processor between the first surface 411 and the second surface 412. The arrangement of one or more components will be described later in FIG. 5B.

FIG. 4 illustrates an example in which the wearable device 400 is configured in a shape to be worn on a user's finger, but the disclosure is not limited thereto. The wearable device 400 may be worn on a part of the user's body and operate. As an example, the wearable device 400 may be worn on one of a user's head, a user's finger, a user's neck, a user's ankle, and a user's ear (or earhole). For example, the wearable device 400 may be worn on a user's wrist. When the wearable device 400 is worn on a user's wrist, the wearable device 400 may be configured like the electronic device 200 of FIGS. 2A and 2B and/or the electronic device 300 of FIG. 3.

According to an embodiment, the wearable device 400 may be used to identify (or recognize) a user's gesture. The wearable device 400 may identify a gesture input that is distinct from a physical input such as a button input and/or a touch input. The wearable device 400 may identify a gesture input based on movement of a body part (e.g., a finger, a wrist, and/or an earhole) of a user wearing the wearable device 400.

According to an embodiment, the wearable device 400 may include a model for identifying a user's gesture. The wearable device 400 may store instructions on a model for identifying a user's gesture. The wearable device 400 may identify the user's gesture by using the model, based on movement of a body part of the user wearing the wearable device 400. The wearable device 400 may transmit the identified gesture (or information on the identified gesture) to the electronic device 480. The electronic device 480 may perform a function corresponding to the identified gesture. For example, the electronic device 480 may execute an application corresponding to the identified gesture. For example, the electronic device 480 may perform a function for an application corresponding to the identified gesture while an application controllable according to a user's gesture is being executed.

FIG. 5A illustrates an example of a simplified block diagram of an electronic device and a wearable device.

Referring to FIG. 5A, a wearable device 400 may operate in a state of being connected to an electronic device 480. For example, the electronic device 480 may be used to control the wearable device 400.

According to an embodiment, the electronic device 480 may include a processor 481, communication circuitry 482, memory 483, and/or a display 484. According to an embodiment, the electronic device 480 may include at least one of the processor 481, the communication circuitry 482, the memory 483, and/or the display 484. For example, at least a portion of the processor 481, the communication circuitry 482, the memory 483, and/or the display 484 may be omitted according to an embodiment.

According to an embodiment, the processor 481 may correspond to the processor 120 of FIG. 1. The processor 481 may be operably coupled or connected with the communication circuitry 482, the memory 483, and the display 484. The processor 481 being operably coupled or connected with the communication circuitry 482, the memory 483, and the display 484 may mean that the processor 481 may control the communication circuitry 482, the memory 483, and the display 484. For example, the communication circuitry 482, the memory 483, and the display 484 may be controlled by the processor 481.

Although illustrated based on different blocks, embodiments are not limited thereto, and a portion (e.g., the processor 481, the communication circuitry 482, and the memory 483) of the hardware of the electronic device 480 may be included in a single integrated circuit such as a system on a chip (SoC).

According to an embodiment, the processor 481 may be configured with at least one processor. For example, the processor 481 may be composed of a main processor performing high-performance processing and an auxiliary processor performing low-power processing.

According to an embodiment, the processor 481 may include a hardware component for processing data based on one or more instructions. For example, the hardware component for processing data may include an arithmetic and logic unit (ALU), a field programmable gate array (FPGA), and/or a central processing unit (CPU).

For example, the processor 481 may include an application processor, a supplementary processor (e.g., a sensor hub, a microcontroller unit (MCU)), a central processor unit (CPU), a neural processing unit (NPU), a graphic processing unit (GPU), and/or a processor for IoT (e.g., a processor integrated with a communication module).

According to an embodiment, the electronic device 480 may include communication circuitry 482. The communication circuit 482 may correspond to at least a portion of the communication module 190 of FIG. 1. For example, the communication circuitry 482 may be used for various radio access technologies (RATs). For example, the communication circuitry 482 may be used to perform Bluetooth communication, wireless local area network (WLAN) communication, Zigbee communication, near field communication (NFC), ultra-wide band (UWB) communication, radio-frequency identification (RFID) communication, or ANT+ communication. For example, the communication circuitry 482 may be used to perform cellular communication. For example, the processor 481 may establish a connection with another electronic device (e.g., the wearable device 400) through the communication circuitry 482. For example, the processor 481 may identify (or measure) a location of the electronic device 480 based on a wireless signal (e.g., global positioning system (GPS)/global navigation satellite system (GNSS) signal) received or transmitted using the communication circuitry 482. According to an embodiment, the communication circuit 482 may be configured integrally with the processor 481.

According to an embodiment, the electronic device 480 may include the memory 483. The memory 483 may be used to store information or data. For example, the memory 483 may be used to store data received from the wearable device 400. For example, the memory 483 may correspond to the memory 130 of FIG. 1. For example, the memory 483 may be a volatile memory unit or units. For example, the memory 483 may be a non-volatile memory unit or units. For example, the memory 483 may be another type of computer-readable medium, such as a magnetic or optical disk. For example, the memory 483 may store data obtained based on an operation (e.g., an algorithm execution operation) performed by the processor 481. According to embodiments, the memory 483 may be configured integrally with the processor 481.

According to an embodiment, the electronic device 480 may include the display 484. The display 484 may output visualized information to the user. For example, the display 484 may be controlled by the processor 481 that includes a circuit such as a graphic processing unit (GPU) to output visualized information to the user. For example, the display 484 may correspond to the display module 160 of FIG. 1.

For example, the processor 481 may display a user interface for changing setting information on the wearable device 400 through the display 484. The processor 481 may display a user interface related to an application for changing setting information on the wearable device 400. An example of the user interface for changing the setting information on the wearable device 400 will be described later.

According to an embodiment, the wearable device 400 connected to the electronic device 480 may include a processor 410, communication circuitry 420, a sensor 430, and/or memory 440. According to an embodiment, the wearable device 400 may include at least one of the processor 410, the communication circuitry 420, the sensor 430, and the memory 440. For example, at least a portion of the processor 410, the communication circuitry 420, the sensor 430, and the memory 440 may be omitted according to an embodiment.

Although illustrated based on different blocks, embodiments are not limited thereto, and a portion (e.g., at least a portion of the processor 410, the communication circuitry 420, the sensor 430, and the memory 440) of the hardware of the wearable device 400 may be included in a single integrated circuit, such as a system on a chip (SoC).

According to an embodiment, the wearable device 400 may include the processor 410. For example, the processor 410 may correspond to the processor 120 of FIG. 1. The processor 410 may be operably coupled or connected with the communication circuitry 420, the sensor 430, and the memory 440. The processor 410 being operably coupled or connected with the communication circuit 420, the sensor 430, and the memory 440 may mean that the processor 410 may control the communication circuitry 420, the sensor 430, and the memory 440. For example, the communication circuitry 420, the sensor 430, and the memory 440 may be controlled by the processor 410.

According to an embodiment, the processor 410 may be configured with at least one processor. For example, the processor 410 may be configured with a main processor performing high-performance processing and an auxiliary processor performing low-power processing. At least a portion of the sensors 430 may be connected to the auxiliary processor. The at least a portion of the sensors connected to the auxiliary processor may obtain data on a user for 24 hours. According to an embodiment, one of the main processor and the auxiliary processor may be activated according to a state and/or an operation of the wearable device 400. As an example, in a state in which a battery of the wearable device 400 is insufficient, the auxiliary processor may be activated. For example, in a state in which accurate data on a user is required, the main processor may be activated.

For example, the processor 481 may include at least one of an application processor, a coprocessor (e.g., a sensor hub or a micro controller unit (MCU)), a central processor unit (CPU), a neural processing unit (NPU), a graphic processing unit (GPU), and/or a processor for the Internet of Things (IoT).

According to an embodiment, the wearable device 400 may include the communication circuitry 420. For example, the communication circuitry 420 may correspond to at least a portion of the communication module 190 of FIG. 1. For example, the communication circuitry 420 may correspond to the communication circuitry 482 of the electronic device 480.

According to an embodiment, the wearable device 400 may include a sensor 430. The sensor 430 may be used to obtain various information. For example, the sensor 430 may be used to obtain information related to a user. The information related to the user may include data on a body of the user.

For example, the sensor 430 may be used to obtain body temperature data (or body temperature information), heart rate data (or heart rate information), and/or motion data (or motion information) of the user. For example, the sensor 430 may be composed of at least one sensor. The sensor 430 may include at least one sensor. For example, the sensor 430 may correspond to the sensor module 176 of FIG. 1.

For example, the sensor 430 may include an acceleration sensor 431. The acceleration sensor 431 may be used to identify a change in acceleration of the wearable device 400. For example, the acceleration sensor 431 may identify (or measure or detect) the acceleration of the wearable device 400 in three directions of the x-axis, y-axis, and z-axis.

For example, the sensor 430 may include a gyro sensor 432. The gyro sensor 432 may identify (or measure and detect) angular velocity (or rotational speed) of the wearable device 400 in three directions of the x-axis, y-axis, and z-axis. For example, the gyro sensor 432 may identify a rotation of the wearable device 400 by identifying the Coriolis effect applied to the wearable device 400.

According to an embodiment, the wearable device 400 may include an inertial sensor including the acceleration sensor 431 and the gyro sensor 432.

For example, the sensor 430 may include a photoplethysmography (PPG) sensor 433. The PPG sensor 433 may be used to measure a pulse (or a change in the blood volume within a blood vessel) by identifying a change in the amount of photosensitive light according to a change in the volume of blood vessel. The PPG sensor 433 may include one or more photodiodes (or one or more light receiving circuits) and one or more light emitting diodes (or one or more light emitting circuits). For example, the PPG sensor 433 may be used to identify a change in blood flow in blood vessel during a heartbeat. The PPG sensor 433 may identify a change in blood flow in a blood vessel during a heartbeat in a state that an optical sensor is in contact with the skin on the peripheral blood vessel. The processor 410 may identify the amount of blood flow and identify the change amount in the amount of blood flow based on the PPG signal and the waveform.

For example, the PPG sensor 433 may include a transmissive PPG sensor and/or a reflective PPG sensor.

As an example, the PPG sensor 433 may output light toward the user's skin through one of LEDs (e.g., green, red, or infrared (IR)), laser, and vertical cavity surface emitting laser (VCSEL). The PPG sensor 433 may identify light reflected and/or transmitted from the user's skin through at least one of PD and/or a complementary metal oxide semiconductor (CMOS) camera. The PPG sensor 433 may store a value identified through an analog to digital converter (ADC) in the memory 440 (or buffer), based on reflected and/or transmitted light.

For example, the transmissive PPG sensor may identify light passing through a blood vessel through a PD disposed on the opposite side of the LED. The transmissive PPG sensor may identify a user's blood flow amount based on strength of light passing through a blood vessel. As an example, the reflective PPG sensor may output light toward the user's skin through an LED. The reflective PPG sensor may identify light, which is reflected by a blood vessel and at least partially received, through a PD disposed on substantially the same surface as the LED. The reflective PPG sensor may identify the user's blood flow amount, based on strength of light reflected in a blood vessel. For example, a multi-light source may be used as the LED. For example, the LED may use green light, which is a complementary color to blood.

For example, the sensor 430 may include a temperature sensor 434. For example, the temperature sensor 434 may measure a skin temperature of a part of the user's body. The user's body temperature may be obtained based on the skin temperature of a part of the user's body obtained through the temperature sensor 434. The temperature sensor 434 may include a contact-type body temperature sensor and/or a non-contact body temperature sensor.

The sensor 430 may further include a sensor for obtaining (or identifying, measuring, or detecting) various data related to a user. For example, the sensor 430 may include a blood glucose sensor. The processor 410 may identify the user's blood glucose level by identifying (or measuring) a current generated by an electro-chemical reaction with the blood glucose in the blood.

According to an embodiment, the processor 410 may correct the data obtained from the sensor 430 based on a correction value stored in the memory 440. The processor 410 may identify corrected values according to characteristics of the sensor 430 by correcting the data. The processor 410 may convert the corrected values into a standard score between a reference range (e.g., a range between 0 and 100).

According to an embodiment, the wearable device 400 may include memory 440. For example, the memory 440 may correspond to the memory 130 of FIG. 1. For example, the memory 440 may correspond to the memory 483 of the electronic device 480.

According to an embodiment, the wearable device 400 may further include various components in addition to the components illustrated in FIG. 5A. An example of the arrangement of components included in the wearable device 400 will be described later with reference to FIG. 5B.

According to an embodiment, a plug-in (e.g., a wearable manager) for controlling the wearable device 400 may be installed in the memory 483 of the electronic device 480. The plug-in may provide a function for linking an application installed in the electronic device 480 with the wearable device 400. For example, an application may be registered in the plug-in. A plurality of functions for a registered application may correspond to each of a plurality of gestures. The electronic device 480 may receive information indicating that one of the plurality of gestures has been performed from the wearable device 400. The electronic device 480 may provide a function for the registered application, corresponding to one of the plurality of gestures.

For example, the electronic device 480 may receive information indicating that a pinch gesture has been performed from the wearable device 400. The electronic device 480 may call back a camera application based on the received information. The camera application may perform a function corresponding to a pinch gesture based on a callback event. As an example, the function according to the pinch gesture may include a function for starting (or stopping) recording in the camera application.

FIG. 5B is an example of a partial cross-sectional view of a wearable device according to an embodiment.

Referring to FIG. 5B, the electronic device 480 may be connected to the wearable device 400. The electronic device 480 may be used to control the wearable device 400. The electronic device 480 may change setting information on the wearable device 400. For example, the wearable device 400 may not include a display. The electronic device 480 may display the setting information of the wearable device 400 on the display of the electronic device 480.

The wearable device 400 may be formed in a ring shape. For example, the housing 401 of the wearable device 400 may be formed in a ring shape wearable on a user's finger. In FIG. 4 or FIG. 5B, the wearable device 400 having a ring shape with a smooth surface is illustrated as an example, but is not limited thereto. For example, the wearable device 400 may be implemented as a housing including a plurality of planes. For example, the wearable device 400 having a ring shape with a non-smooth surface may also be understood as an embodiment of the present disclosure.

Referring to FIGS. 4 and 5B, the ring-shaped housing 401 may include a first surface 411 contacted with the user's body when worn by the user, a second surface 412 exposed to the outside, and a side surface between the first surface 411 and the second surface 412. For example, a space for including (or arranging) at least one component (e.g., the processor 410, the communication circuit 420, the sensor 430, and the memory 440) may be included between the first surface 411 and the second surface 412.

According to an embodiment, a PCB 451 may be disposed between the first surface 411 and the second surface 412 of the wearable device 400. For example, the processor 410, the communication circuitry 420, the acceleration sensor 431, the gyro sensor 432, the PPG sensor 433, the temperature sensor 434, the memory 440, and/or the PMIC 454 may be disposed on the PCB 451. The PCB 451 may be used for packaging at least one of the processor 410, the communication circuitry 420, the acceleration sensor 431, the gyro sensor 432, the PPG sensor 433, the temperature sensor 434, the memory 440, and/or the PMIC 454. At least one or all of the processor 410, the communication circuitry 420, the acceleration sensor 431, the gyro sensor 432, the PPG sensor 433, the temperature sensor 434, the memory 440, and/or the PMIC 454 may be electrically connected through the PCB 451. For example, the PCB 451 may be composed of a rigid region and a flexible region. As an example, the rigid region may be referred to as a rigid flexible printed circuit board (RFPCB). As an example, the flexible region may be referred to as a flexible printed circuit board (FPCB).

For example, the PPG sensor 433 may include one or more light emitting circuits 433-1, one or more light receiving circuits 433-2, and a control circuit 433-3. As an example, the one or more light emitting circuits 433-1 and the one or more light receiving circuits 433-2 may be disposed toward the first surface 411. As an example, the control circuit 433-3 may be disposed toward the second surface 412.

For example, one or more light emitting circuits 433-1 may be used to emit (or radiate) light to the user's skin. The one or more light emitting circuits 433-1 may be configured based on at least one of a lamp, a light emitting diode (LED), a laser, and/or a vertical-cavity surface emitting laser (VCSEL).

For example, the one or more light receiving circuits 433-2 may be used to measure (or identify) light passing through the user's skin. The one or more light receiving circuits 433-2 may be configured based on at least one of a photodiode (PD) and/or an image sensor (e.g., complementary metal oxide semiconductor (CMOS)).

For example, the control circuit 433-3 may drive the one or more light emitting circuits 433-1 and receive a signal from the one or more light receiving circuits 433-2. The control circuit 433-3 may perform filtering and/or amplification on the signal. For example, the control circuit 433-3 may be configured based on an integrated circuit. As an example, the control circuit 433-3 may be configured based on an analog front end (AFE) and/or a power management integrated circuit (PMIC) for supplying power to the one or more light emitting circuits 433-1 and/or the one or more light receiving circuits 433-2.

Although not illustrated, the PPG sensor 433 may further include memory. For example, the memory included in the PPG sensor 433 may be configured based on at least one of flash memory, NOR flash memory, and/or electrically erasable programmable read-only memory (EEPROM).

For example, the PMIC 454 may be used to manage power of the wearable device 400. The PMIC 454 may be used to provide (or distribute) power to components that require power in the wearable device 400. The PMIC 454 may support a wired charging method (e.g., terminal, pogo pin) or a wireless charging method (e.g., wireless power consortium (WPC), NFC) for charging the wearable device 400 through a charging interface 453.

According to an embodiment, a battery 452 may be disposed between the first surface 411 and the second surface 412 of the wearable device 400. The battery 452 may be composed of at least one battery (or battery pack). For example, the battery 452 may be configured such that at least one battery is connected in series and/or in parallel. For example, the battery 452 may be composed of a flexible battery pack. For example, the battery 452 may be charged and/or discharged as a secondary battery. For example, the battery 452 may be composed of various materials. As an example, the material constituting the battery 452 may include at least one of lithium ion and mercury.

According to an embodiment, an antenna 455 may be disposed between the first surface 411 and the second surface 412 of the wearable device 400. For example, the antenna 455 may be composed of a single antenna and/or a plurality of segmented antennas. According to an embodiment, the antenna 455 may be composed as a part of the housing 401 of the wearable device 400. For example, the antenna 455 may be electrically connected to the communication circuitry 420 through the PCB 451.

Although not illustrated, the wearable device 400 may include various components in addition to the components illustrated above. For example, the wearable device 400 may include a display. The display may be disposed on the outer surface of the housing 401.

According to an embodiment, at least one of an image sensor and/or another sensor (e.g., an inertial sensor including the acceleration sensor 431 and the gyro sensor 432) distinct from the image sensor may be used to identify a gesture of a user wearing the wearable device 400. For example, in case that the inertial sensor including the acceleration sensor 431 and the gyro sensor 432 is used to identify a gesture of a user, the user's gesture may be identified at any time when the user wears the wearable device 400. On the other hand, in case that an image sensor is used to identify a gesture of a user, the user's gesture may not be identified in a dark environment or an environment where the camera is covered. Therefore, in case that the inertial sensor is used to identify a gesture of a user rather than the image sensor, usability may be improved.

For example, the wearable device 400 may include a model (e.g., an artificial intelligence model) for identifying a user's gesture. The wearable device 400 may identify a user's gesture using the model. The model may be trained based on time series data of the inertial sensor. Since muscle movements differ according to a gesture, different signal patterns may be identified according to the gesture. The model may be trained based on signal patterns in accordance with each of a plurality of gestures. Accordingly, the wearable device 400 may identify one of the plurality of gestures based on data obtained through the inertial sensor. In the following specification, a specific operation for identifying one of the plurality of gestures based on data obtained through an inertial sensor (e.g., the acceleration sensor 431 and the gyro sensor 432) in the wearable device 400 will be described.

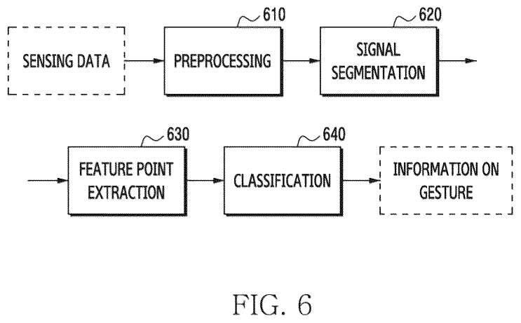

FIG. 6 illustrates an example of an operation of a wearable device for identifying a user's gesture according to an embodiment.

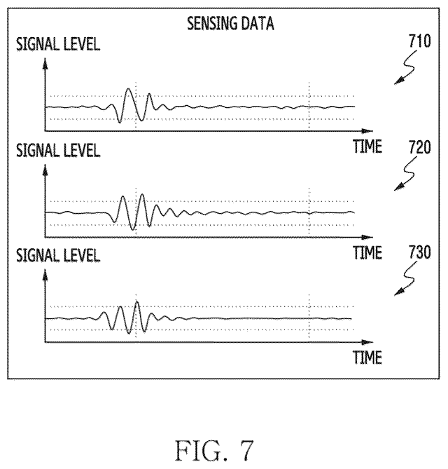

FIG. 7 illustrates an example of data obtained through an acceleration sensor according to an embodiment.

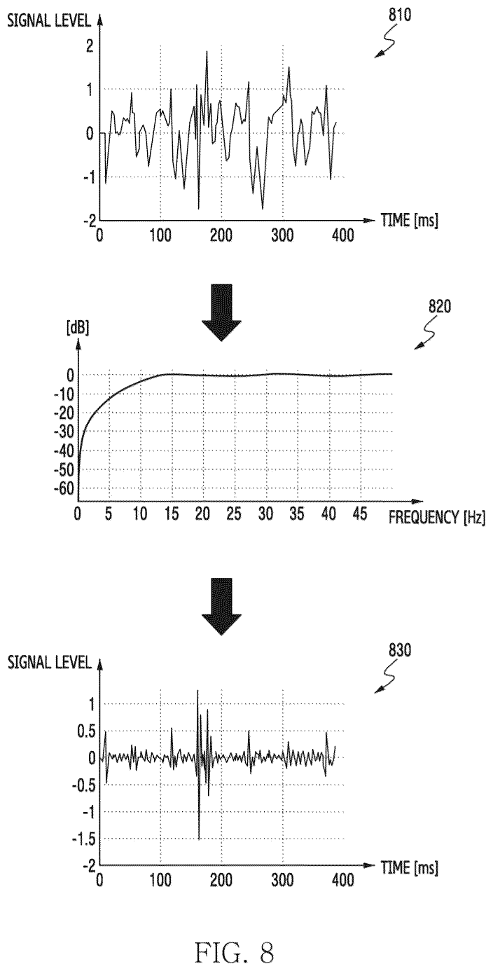

FIG. 8 illustrates an example of a preprocessing operation according to an embodiment.

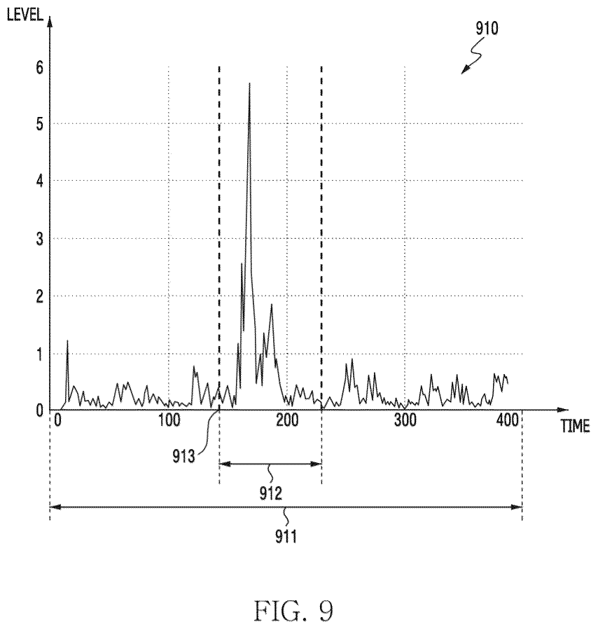

FIG. 9 illustrates an example of a signal segmentation operation according to an embodiment.

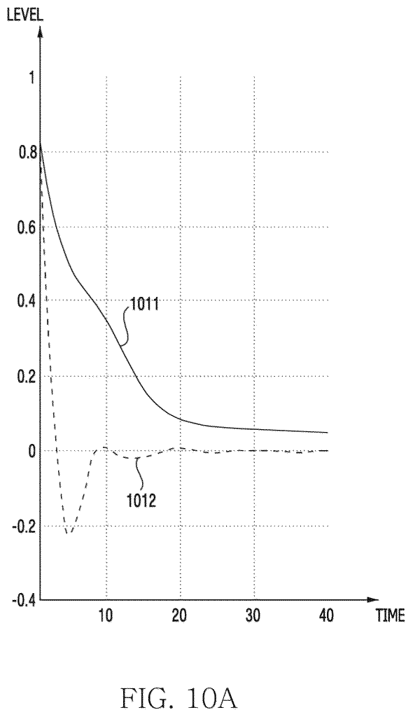

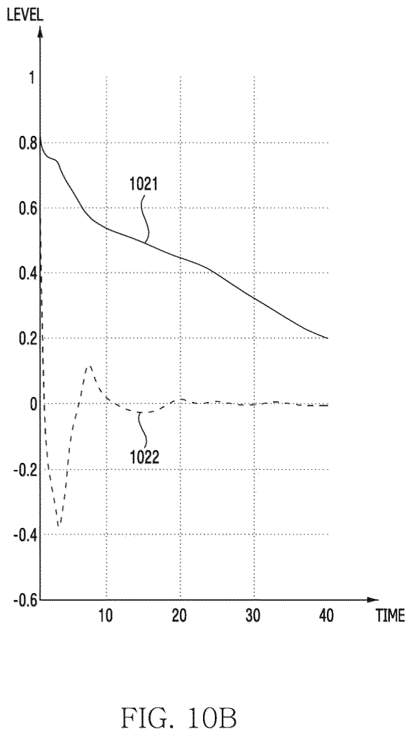

FIGS. 10A and 10B illustrate an example of a feature point extraction operation according to an embodiment.

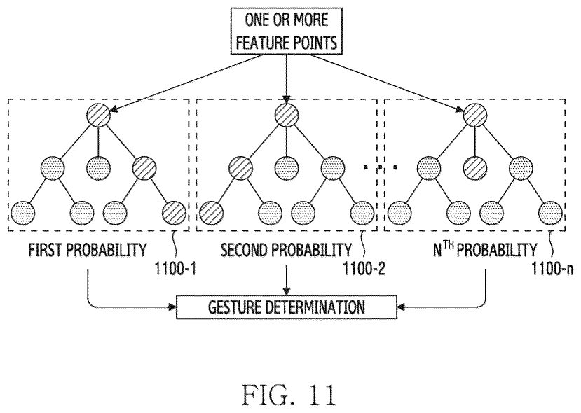

FIG. 11 illustrates an example of a classification operation according to an embodiment.

In the following embodiment, each operation may be performed sequentially, but is not necessarily performed sequentially. For example, the sequence of each operation may be changed, and at least two operations may be performed in parallel.

Referring to FIG. 6, in operation 610, a wearable device 400 (or a processor 410 of the wearable device 400) may obtain sensing data using a sensor 430 (e.g., an acceleration sensor 431 and/or a gyro sensor 432).

The wearable device 400 may obtain data on acceleration of the wearable device 400 using the acceleration sensor 431. The data on acceleration may include acceleration values on the x-axis, y-axis, and z-axis. The acceleration values on the three axes (e.g., x-axis, y-axis, and z-axis) may be obtained based on sampling within a specified time interval.

Referring to FIG. 7, a graph 710 indicates acceleration along the x-axis over time. A graph 720 indicates acceleration along the y-axis over time. A graph 730 indicates acceleration along the z-axis over time. For example, the wearable device 400 may obtain a first value regarding acceleration along the x-axis, a second value regarding acceleration along the y-axis, and a third value regarding acceleration along the z-axis at a specific time point by using the acceleration sensor 431. According to an embodiment, the wearable device 400 may obtain magnitude of acceleration at a specific time point. The magnitude of acceleration may be obtained based on the first value, the second value, and the third value.

Referring back to FIG. 6, the wearable device 400 may obtain data regarding angular velocity of the wearable device 400 by using the gyro sensor 432. The data regarding the angular velocity may include values regarding a rotational speed of the wearable device 400 rotating around the x-axis, y-axis, and z-axis. The values regarding the rotational speed of the wearable device 400 rotating around three axes (e.g., the x-axis, y-axis, and z-axis) may be obtained by sampling within a specified time interval.

According to an embodiment, the wearable device 400 may identify (or obtain) information on a gesture based on sensing data, by performing operations 610 to 640. The information on a gesture may indicate a gesture indicated by the user's movement.

In operation 610, the wearable device 400 may perform a pre-processing operation. For example, based on the pre-processing operation of the wearable device 400, first data having a reference frequency band among the sensing data may be obtained. For example, based on the pre-processing operation, the wearable device 400 may obtain first data having a frequency exceeding the reference frequency (e.g., a cut-off frequency) among the sensing data. The wearable device 400 may perform a pre-processing operation to remove noise.

Referring to FIG. 8, a graph 810 indicates a change in acceleration along the x-axis over time. The graph 810 may indicate x-axis acceleration data. The graph 810 may correspond to a portion of the graph 710 of FIG. 7.

According to an embodiment, the wearable device 200 may filter the x-axis acceleration data by performing filtering for a specific frequency band. For example, the wearable device 400 may filter the x-axis acceleration data by using a high pass filter. The high pass filter may be configured as shown in a graph 820. The wearable device 400 may filter the x-axis acceleration data using the high pass filter to remove movement indicated as a low frequency signal.

For example, since the human body is connected through joints, movement of one body part may cause movement of other body parts. For example, in case that the wearable device 400 is worn on the user's finger, the user's torso, shoulder, elbow, wrist, and finger are organically connected, so a low-frequency signal may be identified according to movement of other body parts (e.g., torso, shoulder, elbow, and/or wrist) other than the finger. Therefore, the wearable device 400 may remove a signal in a specific frequency band generated according to the movement of other body parts, in order to prevent the user's light movement (or small movement) from being identified as movement for performing a gesture. The wearable device 400 may obtain first data having a reference frequency band by removing a signal in a specific frequency band.

For example, the wearable device 400 may remove a signal having a frequency lower than the cut-off frequency, based on the cut-off frequency, from the x-axis acceleration data. According to the embodiment, the cut-off frequency may be changed according to a type, a shape, a signal size, and/or a wearing position of the wearable device 400. For example, in case that the wearable device 400 is configured in a form of a watch, the cut-off frequency may be set to 8 [Hz]. In case that the wearable device 400 is configured in a form of a ring, the cut-off frequency may be set to 5 [Hz].

A graph 830 indicates x-axis acceleration data filtered using a high pass filter. The x-axis acceleration data filtered using a high-pass filter may be configured based on a signal having a frequency exceeding the cut-off frequency.

In the above-described embodiment, an example of filtering the x-axis acceleration data using a high pass filter has been described, but is not limited thereto. For example, the x-axis acceleration data may be filtered using at least one of a band pass filter, a low pass filter, and/or the high pass filter.

In FIG. 8, an example of performing a preprocessing operation based on the x-axis acceleration data has been described, but this is for convenience of explanation and is not limited thereto. The wearable device 400 may perform a preprocessing operation based on sensing data (e.g., x-axis acceleration data, y-axis acceleration data, z-axis acceleration data, x-axis angular velocity data, y-axis angular velocity data, z-axis angular velocity data).

Referring back to FIG. 6, in operation 620, the wearable device 400 may perform a signal segmentation operation. The wearable device 400 may perform the signal segmentation operation based on first data having a reference frequency band among the sensing data (e.g., first data having a frequency exceeding a reference frequency). For example, the wearable device 400 may identify a second time interval regarding at least one value exceeding a threshold value among the values identified based on the first data within a first time interval.

For example, the wearable device 400 may identify a second time interval regarding at least one value exceeding the threshold value among the values identified based on the first data within the first time interval, in order to identify a time interval in which movement regarding a gesture occurred.

For example, the values identified based on the first data may be related to magnitude of the acceleration identified through the acceleration sensor 431. For example, the values identified based on the first data may be related to energy related to the acceleration.

Referring to FIG. 9, a graph 910 may indicate a change in acceleration magnitude of the wearable device 400 over time. The acceleration magnitude (or acceleration energy magnitude) of the wearable device 400 may be identified based on the following equation.

$$E [ t ] = {ACCX [ t ]}^{2} + {ACCY [ t ]}^{2} + {ACCZ [ t ]}^{2} \qquad [ Equation 1 ]$$

Referring to Equation 1, E[t] is magnitude of acceleration (or magnitude of acceleration energy) at time t. ACCX[t] is an acceleration value for the x-axis at time t. ACCY[t] is an acceleration value for the y-axis at time t. ACCZ[t] is an acceleration value for the z-axis at time t.

The wearable device 400 may identify a time interval in which energy regarding acceleration is greater than or equal to a threshold value. In order to identify the time interval in which the energy regarding acceleration is greater than or equal to the threshold value, the wearable device 400 may identify a second time interval satisfying the following equation.

$${\sum }_{t = 1}^{T} ( E [ t ] ) > {E}_{th} \qquad [ Equation 2 ]$$

Referring to Equation 2, Eth is a threshold value. T is the number of samples determined according to a determination time interval and a sampling period. The determination interval may mean a time interval for identifying energy. The determination interval may be fixed.

The wearable device 400 may identify the second time interval satisfying Equation 2 by using a sliding window technique. According to an embodiment, the wearable device 400 may identify a second time interval 912 satisfying Equation 2 among the first time interval 911. According to an embodiment, the wearable device 400 may identify a period from a time point satisfying Equation 2 among the first time interval 911 to a reference time (e.g., 1 second) as the second time interval 912.

According to an embodiment, the wearable device 400 may identify the second data corresponding to the second time interval among the first data.

For example, the wearable device 400 may identify the second time interval 912 satisfying Equation 2 among the first time interval, and identify (or acquire) the second data corresponding to the identified second time interval 912 among the first data.

For example, in a continuously received signal (e.g., a signal according to the graph 910), the wearable device 400 may identify a time interval in which energy during the determination interval exceeds a threshold value. The wearable device 400 may identify a time point 913, which is a start time point of the time interval. The wearable device 400 may identify a period from the time point 913 to a reference time (e.g., 1 second) as the second time interval 912.

Referring back to FIG. 6, as the above-described threshold value is set lower, sensitivity of the wearable device 400 may increase. As the above-described threshold value is set higher, the sensitivity of the wearable device 400 may decrease.

For example, as the threshold value is set lower, operations 630 and 640, which are operations after operation 620, may be performed even when the user performs a gesture with a small force. Accordingly, the wearable device 400 may identify a gesture according to the user's movement even when the user performs a gesture with a small force. For example, a threshold value being set low may mean that sensitivity of the wearable device 400 is set high. In case that the sensitivity of the wearable device 400 increases, even small movement may be identified as a gesture, and thus accuracy of gesture identification may be lowered.

For example, as the threshold value is set higher, operations 630 and 640, which are operations after operation 620, may be performed only when the user performs a gesture with great force. For example, a threshold value being set high may mean that sensitivity of the wearable device 400 is set low. In case that the sensitivity of the wearable device 400 is lowered, the accuracy of gesture identification may increase, but the convenience of the user may decrease.

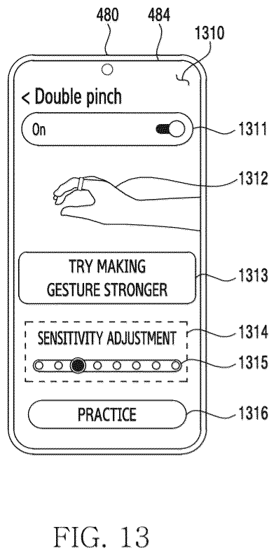

According to an embodiment, the electronic device 480 may provide an application (or user interface) for changing the sensitivity of the wearable device 400. The user of the wearable device 400 may change the sensitivity of the wearable device 400 by using the electronic device 480. For example, the electronic device 480 may provide a user interface for changing a threshold value used to identify a user's gesture. A specific example of the user interface for changing the threshold value will be described later with reference to FIG. 13.

Referring back to FIG. 6, in operation 630, the wearable device 400 may perform a feature point extraction operation. For example, the wearable device 400 may identify one or more feature points based on identifying the second data corresponding to the second time interval among the first data. The wearable device 400 may identify (or obtain) one or more feature points based on the second data.

According to an embodiment, various feature points may be identified (or obtained or extracted). For example, the feature point may include coefficients of an equation indicating a graph of the second data. For example, the feature point may include a maximum value, a minimum value, a peak value, and/or the number of peak occurrences with respect to the second data. For example, the feature point may include at least one value identified according to at least one of a fast Fourier transform (FFT) operation and/or a continuous wavelet transform (CWT) operation on the second data.

Referring to FIGS. 10A and 10B, each of a graph 1011, a graph 1012, a graph 1021, and a graph 1022 is a graph for values identified according to feature point extraction.

For example, the graphs 1011 and 1021 indicate magnitude of acceleration over time. The graphs 1012 and 1022 indicate magnitude of angular velocity over time.

For example, the magnitude of acceleration may be obtained based on acceleration values for three axes. The wearable device 400 may obtain a first value for acceleration along the x-axis, a second value for acceleration along the y-axis, and a third value for acceleration along the z-axis at a specific time point using the acceleration sensor 431. The magnitude of acceleration may be obtained based on the first value, the second value, and the third value. An acceleration vector may be configured based on the first value, the second value, and the third value. The wearable device 400 may identify the magnitude of acceleration by identifying the magnitude of the acceleration vector.

For example, the magnitude of the angular velocity may be obtained based on values for the rotational speed of the wearable device 400 rotating around the x-axis, y-axis, and z-axis. The wearable device 400 may obtain a fourth value of the angular velocity along the x-axis, a fifth value of the angular velocity along the y-axis, and a sixth value of the angular velocity along the z-axis at a specific time point. The magnitude of the angular velocity may be obtained based on the fourth value, the fifth value, and the sixth value. An angular velocity vector may be configured based on the fourth value, the fifth value, and the sixth value. The wearable device 400 may identify the magnitude of the angular velocity by identifying the magnitude of the angular velocity vector.

Referring to FIG. 10A, the wearable device 400 may obtain acceleration values for three axes using the acceleration sensor 431, based on a first gesture (e.g., shake gesture) of the user. The wearable device 400 may identify, based on the acceleration values for the three axes, the magnitude of the acceleration as a feature point. The magnitude of the acceleration over time may be configured as in the graph 1011.

The wearable device 400 may obtain values (hereinafter, angular velocity values) for the rotational speed of the wearable device 400 rotating around the x-axis, y-axis, and z-axis, by using the gyro sensor 432, based on the user's first gesture. The wearable device 400 may identify the magnitude of the angular velocity as a feature point, based on the angular velocity values for the three axes. The magnitude of the angular velocity over time may be configured as in the graph 1012.

Referring to FIG. 10B, the wearable device 400 may obtain acceleration values for three axes using the acceleration sensor 431, based on a second gesture (e.g., double pinch gesture) of the user. The wearable device 400 may identify the magnitude of the acceleration as a feature point, based on the acceleration values for the three axes. The magnitude of the acceleration over time may be configured as in the graph 1021.

The wearable device 400 may obtain values (hereinafter, angular velocity values) for the rotational speed of the wearable device 400 rotating around the x-axis, y-axis, and z-axis by using the gyro sensor 432, based on the user's second gesture. The wearable device 400 may identify the magnitude of the angular velocity as a feature point, based on the angular velocity values for the three axes. The magnitude of the angular velocity over time may be configured as in the graph 1022.

According to an embodiment, the wearable device 400 may identify one or more feature points for data (or signal value) obtained from other sensors as well as the acceleration sensor 431 and/or the gyro sensor 432. The wearable device 400 may identify one or more feature points for data obtained from various sensors.

Referring back to FIG. 6, in operation 640, the wearable device 400 may perform a classification operation. The wearable device 400 may perform a classification operation based on one or more feature points obtained according to operation 630. The classification operation may be an operation of identifying a gesture corresponding to movement of a part of the user's body among a plurality of gestures.

For example, the wearable device 400 may set one or more feature points as an input of a model (e.g., an artificial intelligence model) for identifying a user's gesture. The wearable device 400 may determine a gesture corresponding to movement of a part of the user's body among a plurality of gestures, based on output of the model.

For example, the wearable device 400 may configure a model for identifying a user's gesture based on various artificial intelligence models. For example, the model may be trained based on various parameters (e.g., feature points). When parameters used for training the model increase, a size of the model increases, but the accuracy may be improved.

As an example, a model for identifying a user's gesture may be configured based on a decision tree network. An example of a model for identifying a user's gesture configured based on a decision tree network may be configured as shown in FIG. 11.

Referring to FIG. 11, a model for identifying a user's gesture may be configured based on a plurality of decision trees. The plurality of decision trees may include a decision tree 1100-1 to a decision tree 1100-n. One decision tree may output a probability value for one gesture. For example, the decision tree 1100-1 may output a probability value for a first gesture. The decision tree 1100-n may output a probability value for an n-th gesture.

For example, one or more feature points may be set as an input to the plurality of decision trees. Each of the plurality of decision trees may provide a path to a branch of the right or left, based on a binary decision. A probability value for a gesture may be determined based on last nodes (or leaves) of one decision tree.

For example, one decision tree may be composed of a plurality of trees. Each of the plurality of trees may indicate whether movement of the user corresponds to a corresponding gesture. One or more feature points may be set as input data of the plurality of trees. As an example, the decision tree 1100-1 may be composed of five trees. Each of the five trees may indicate whether the user's movement corresponds to the first gesture. If it is determined that the user's movement in three trees of the five trees corresponds to the first gesture, a probability value for the first gesture may be identified as 0.6.

A gesture may be determined based on a probability value for each of a plurality of gestures. A majority voting method or an averaging method may be used to determine a gesture. For example, if a probability value for the first gesture is higher than probability values for other gestures, a gesture corresponding to the user's movement may be identified as the first gesture.

According to an embodiment, a condition, a threshold value and/or a return value for a node, a branch and a leaf for each of a plurality of decision trees may be optimized by a learning algorithm, and gesture recognition performance may be improved according to the optimization.

Referring back to FIG. 6, the wearable device 400 may obtain information on a gesture using operation 640. The information on the gesture may indicate a gesture corresponding to movement of the user. For example, the wearable device 400 may transmit the information on the gesture to the electronic device 480. The electronic device 480 may perform a function corresponding to a gesture indicated according to the information on the gesture.

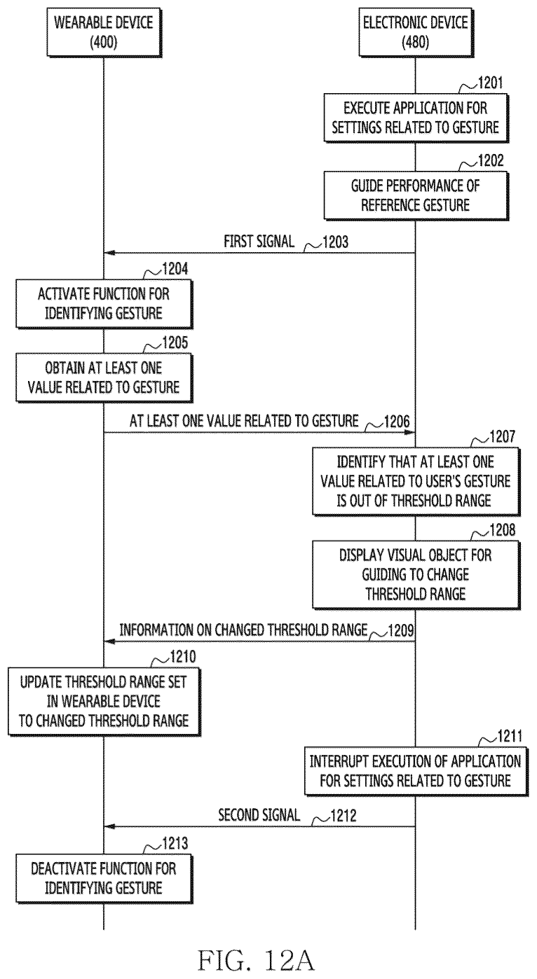

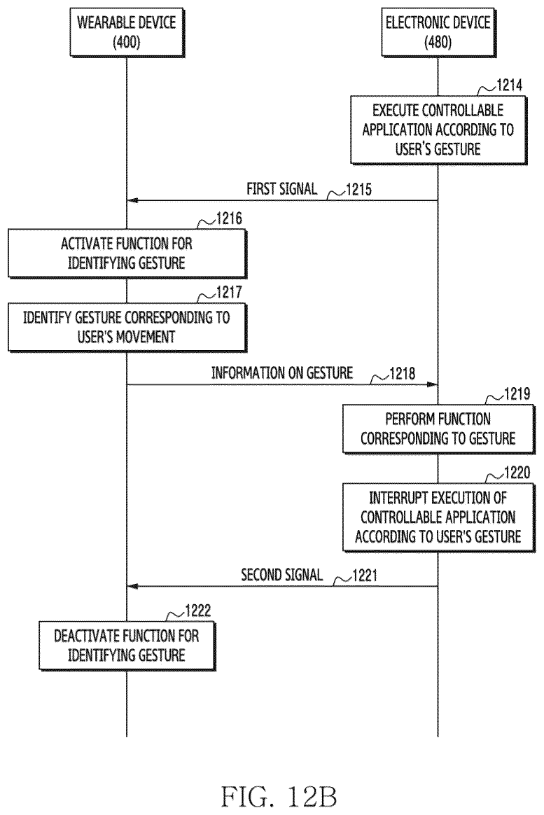

FIGS. 12A and 12B illustrate an example of an operation of an electronic device and a wearable device for changing sensitivity of the wearable device, according to an embodiment.

Referring to FIGS. 12A and 12B, an electronic device 480 may set (or change) sensitivity of a wearable device 400. The electronic device 480 may set the sensitivity of the wearable device 400 by changing a threshold value used for signal segmentation. The electronic device 480 may identify whether at least one value related to a gesture obtained from the wearable device 400 is out of a threshold range. Based on identifying that the at least one value related to the gesture obtained from the wearable device 400 is out of the threshold range related to a reference gesture, the threshold range may be changed. For example, the threshold range may be a range for checking whether the sensitivity of the wearable device 400 is appropriately set. The threshold value may be a reference value used to perform signal separation in the wearable device 400.

The electronic device 480 may identify that the threshold value is properly set, based on identifying that at least one value related to the gesture is included within a threshold range determined according to the threshold value. The electronic device 480 may identify that the threshold value is set inappropriately based on identifying that the at least one value related to the gesture is out of the threshold range determined according to the threshold value. The threshold value may correspond to the threshold value according to operation 620 of FIG. 6. According to operations 1201 to 1213 described below, the wearable device 400 and the electronic device 480 may change a threshold range set in the wearable device 400. According to operations 1214 to 1222 described below, the wearable device 400 may identify a gesture corresponding to the user's movement according to the changed threshold range. The electronic device 480 may perform a function corresponding to the identified gesture.

In operation 1201, the electronic device 480 may execute an application for managing settings related to a gesture. For example, the electronic device 480 may be connected to the wearable device 400. The electronic device 480 may establish a connection with the wearable device 400 using at least one of Bluetooth, Bluetooth low energy (BLE), and/or wireless LAN.

For example, an application for managing settings related to a gesture may correspond to an application for changing setting information of the wearable device 400. The electronic device 480 may display, via the display 484, a user interface of an application for managing settings related to a gesture. For example, the wearable device 400 may not include an output interface such as a display. Accordingly, the electronic device 480 may display a user interface of an application for managing settings related to a gesture to change setting information (e.g., sensitivity) on the wearable device 400.

In operation 1202, the wearable device 400 may guide performance of a reference gesture. For example, the wearable device 400 may display, via the display 484, a screen for guiding the performance of the reference gesture through a part of the user's body on which the wearable device 400 is worn. A screen for guiding the performance of the reference gesture may be displayed based on a user interface of an application for managing settings related to a gesture.

For example, electronic device 480 may display, via the display 484, a screen for guiding the performance of the reference gesture to identify whether a threshold range set in the wearable device 400 is appropriate.

In operation 1203, the electronic device 480 may transmit a first signal to the wearable device 400. For example, the electronic device 480 may transmit, to the wearable device 400, a first signal for causing the wearable device 400 to activate a function for identifying one of a plurality of gestures.

For example, the electronic device 480 may execute an event for activating a function for identifying a gesture of the wearable device 400. The electronic device 480 may transmit, to the wearable device 400, at least one of information on a gesture guided to the user and/or information on an application (e.g., an application for managing settings related to a gesture) via the first signal.

In operation 1204, the wearable device 400 may activate a function for identifying a gesture based on the first signal. For example, the wearable device 400 may activate a function for identifying one of the plurality of gestures, based on the first signal. For example, the wearable device 400 may activate at least one of the acceleration sensor 431 and/or the gyro sensor 432. For example, the wearable device 400 may activate a function related to a gesture classification operation (e.g., operation 640 of FIG. 6).

In operation 1205, the wearable device 400 may obtain at least one value related to a gesture. For example, the wearable device 400 may obtain at least one value related to a gesture of a user, based on movement of a part of a body of the user wearing the wearable device 400. For example, at least one value related to the user's gesture may include an acceleration value (or an angular velocity value) over time.

In operation 1206, the wearable device 400 may transmit at least one value related to the gesture to the electronic device 480. The electronic device 480 may obtain at least one value related to the user's gesture obtained from the wearable device 400.

In operation 1207, the electronic device 480 may identify that at least one value related to the user's gesture is out of a threshold range related to the reference gesture. For example, the electronic device 480 may identify whether at least one value related to the user's gesture is less than or greater than the threshold range.

For example, when at least one value related to the user's gesture is less than the threshold range, the wearable device 400 may be in a state in which sensitivity is set low (or a state in which the threshold value is set high). For example, when at least one value related to the user's gesture is greater than the threshold range, the wearable device 400 may be in a state in which sensitivity is set high (or a state in which the threshold value is set low).

In operation 1208, the electronic device 480 may display a visual object for guiding to change the threshold range. For example, the electronic device 480 may display, within a screen for guiding the performance of the reference gesture, via the display 484, a visual object for guiding to change the threshold range.

For example, the visual object for guiding to change the threshold range may include a slider for changing the threshold range. For example, the visual object for guiding to change the threshold range may include a drop-down menu for setting the threshold range. However, it is not limited thereto.

According to an embodiment, the electronic device 480 may guide the repeated performance of the reference gesture. The electronic device 480 may guide the repeated performance of the reference gesture to identify average movement for performing the reference gesture.

According to an embodiment, the electronic device 480 may display an object for providing feedback on intensity of the user's gesture, based on at least one value related to the user's gesture. For example, the intensity of the gesture may be identified based on a range or speed or strength associated with a part of the body that moves to perform the gesture. For example, intensity when performing a gesture may be identified based on a range, speed, or strength of movement and combination thereof, according to a situation. For example, in a case where the range and speed of movement are the same, the gesture's intensity (or the gesture) may be identified based on the difference in strength.

For example, the electronic device 480 may display, via the display 484, an object for guiding to reduce the intensity of the user's gesture, based on at least one value related to the user's gesture exceeding the threshold range. The electronic device 480 may identify that the intensity of the gesture performed by the user is high, based on at least one value related to the user's gesture exceeding the threshold range. Accordingly, the electronic device 480 may display, via the display 484, an object for guiding to reduce the intensity of the user's gesture.

For example, the electronic device 480 may display, via the display 484, an object for guiding to increase the intensity of the user's gesture, based on at least one value related to the user's gesture below the threshold range. The electronic device 480 may identify that the intensity of the gesture performed by the user is low, based on at least one value related to the user's gesture below the threshold range. Accordingly, the electronic device 480 may display, via the display 484, an object for guiding to increase the intensity of the user's gesture.

As described above, based on providing feedback on the intensity of the user's gesture, the electronic device 480 may change the threshold range (or threshold value) while simultaneously inducing a change in the intensity of the user's gesture. According to an embodiment, the electronic device 480 may identify average intensity of the user's gesture based on providing feedback on the intensity of the user's gesture.

In operation 1209, according to an input regarding the visual object, the wearable device 400 may change the threshold range and transmit information on the changed threshold range to the wearable device 400.

In operation 1210, the wearable device 400 may update the threshold range set in the wearable device 400 to the changed threshold range. For example, the threshold range set in the wearable device 400 may be set based on a threshold value for identifying a gesture performed by a user as a reference gesture. Based on changing (or updating) the threshold range, the wearable device 400 may change the threshold value for identifying a gesture performed by a user as the reference gesture.

For example, the threshold value may be used as a reference value for performing signal segmentation. The wearable device 400 may obtain first data on the movement of a part of the user's body within the first time interval, and identify a second time interval for at least one value exceeding the threshold value among the identified values based on the first data. The wearable device 400 may identify the second data corresponding to the second time interval among the first data, and identify one or more feature points based on the second data. The wearable device 400 may identify the gesture using one or more feature points. Like the operations of the wearable device 400 described above, the threshold value may be used to identify the second time interval. The threshold value may correspond to Eth of Equation 2 described above.

According to an embodiment, a threshold value before the threshold value is changed may be set to a default value. The threshold value may be optimized according to the user based on operation 1210.

In operation 1211, the electronic device 480 may interrupt execution of an application for managing settings related to a gesture. The electronic device 480 may interrupt the execution of the application for managing settings related to a gesture after the threshold range set in the wearable device 400 is updated to the changed threshold range.

In operation 1212, the electronic device 480 may transmit the second signal to the wearable device 400. For example, the electronic device 480 may transmit, to the wearable device 400, a second signal for causing the wearable device 400 to deactivate a function for identifying a gesture, based on interruption (or termination) of the execution of the application for managing settings related to the gesture.

In operation 1213, the wearable device 400 may deactivate a function for identifying a gesture based on the second signal. For example, the wearable device 400 may deactivate a function for identifying one gesture among a plurality of gestures, based on the second signal. For example, the wearable device 400 may deactivate at least one of the acceleration sensor 431 and/or the gyro sensor 432. For example, the wearable device 400 may deactivate a function related to a gesture classification operation (e.g., operation 640 of FIG. 6).

According to the above-described operations 1201 to 1213, the electronic device 480 may provide a user interface for changing the sensitivity of the wearable device 400. By changing sensitivity (e.g., a threshold range) of the wearable device 400 based on the movement of the user performing the reference gesture, the electronic device 480 may increase a recognition rate of the gesture and reduce a false detection probability of the gesture.

Referring to FIG. 12B, in operation 1214, the electronic device 480 may identify a execution of a controllable application according to the user's gesture. The electronic device 480 may identify the execution of a controllable application according to the user's gesture after the operations for changing the sensitivity of the wearable device (400) are performed.

In operation 1215, the electronic device 480 may transmit, to the wearable device 400, a first signal. For example, the electronic device 480 may transmit, to the wearable device 400, a first signal for causing the wearable device 400 to activate a function for identifying one of a plurality of gestures.

In case that a function for identifying a gesture is activated even when a controllable application according to a user's gesture is not executed, power consumption of the wearable device 400 may increase. Accordingly, the electronic device 480 may transmit, to the wearable device 400, a first signal for causing the wearable device 400 to activate a function for identifying one of a plurality of gestures, based on identifying that the controllable application according to a user's gesture is executed.

In operation 1216, the wearable device 400 may activate a function for identifying a gesture based on the first signal. Operation 1216 may correspond to operation 1204.

In operation 1217, the wearable device 400 may identify a gesture corresponding to the user's movement. For example, the wearable device 400 may identify a gesture corresponding to the user's movement by performing operations 610 to 640 of FIG. 6.

In operation 1218, the wearable device 400 may transmit information on the gesture to the electronic device 480. The information on the gesture may indicate a gesture corresponding to the user's movement. For example, information on the gesture may indicate that one of the plurality of gestures has been performed. For example, the wearable device 400 may transmit, to electronic device 480, an event indicating that the gesture has been performed.

In operation 1219, the electronic device 480 may perform a function corresponding to a gesture, based on information on the gesture. For example, the electronic device 480 may perform a function on an application corresponding to the identified gesture. For example, information on the gesture may be delivered to the application by a callback registered in the application. Based on the callback, a function corresponding to the gesture may be performed in the application.

In operation 1220, the electronic device 480 may interrupt the execution of the controllable application according to the user's gesture.

In operation 1221, the electronic device 480 may transmit a second signal to the wearable device 400. The electronic device 480 may transmit, to the wearable device 400, the second signal for causing the wearable device 400 to deactivate a function for identifying a gesture, based on interruption (or termination) of the execution of the controllable application according to the user's gesture.

In operation 1222, the wearable device 400 may deactivate a function for identifying a gesture based on the second signal. For example, the wearable device 400 may deactivate a function for identifying one gesture among a plurality of gestures, based on the second signal. For example, the wearable device 400 may deactivate at least one of the acceleration sensor 431 and/or the gyro sensor 432. For example, the electronic device 480 may deactivate a function for identifying a gesture in the wearable device 400 by using the plug-in.

FIG. 13 illustrates an example of a screen for changing sensitivity of a wearable device according to an embodiment.

Referring to FIG. 13, a screen 1310 for performing operations 1201 to 1211 of FIG. 12 may be displayed. An electronic device 480 (or a processor 481 of the electronic device 480) may display the screen 1310 for guiding performance of a reference gesture.

According to an embodiment, the electronic device 480 may identify execution of an application for managing settings related to a user's gesture. The screen 1310 may include a user interface of the application for managing settings related to the user's gesture. The screen 1310 may be displayed based on the user interface of the application for managing settings related to the user's gesture.

For example, the screen 1310 (or user interface) may include a toggle button 1311 indicating whether a reference gesture is activated. When the toggle button 1311 indicates deactivation of the reference gesture, the reference gesture may not be identified in the wearable device 400. When the toggle button 1311 indicates activation of the reference gesture, the reference gesture may be identified in the wearable device 400.

For example, the screen 1310 may include a visual object 1312 indicating the reference gesture. The visual object 1312 may be displayed to guide the reference gesture to the user. The visual object 1312 may be changed over time to indicate the reference gesture.

According to an embodiment, the screen 1310 may include a region 1314 for changing sensitivity of the wearable device 400. The region 1314 may include a visual object 1315 for guiding to change the sensitivity of the wearable device 400. A visual object 1315 may be referred to as a visual object for guiding to change a threshold range. For example, the visual object 1315 may include a slider. The wearable device 400 may change the sensitivity of the wearable device 400 based on an input for the visual object 1315.

For example, the visual object 1315 may be displayed in various forms as well as a slider. As an example, the visual object 1315 may include a drop-down menu, a checkbox, a radio button, and/or a chip.

According to an embodiment, the screen 1310 may display an object 1313 for providing feedback on a gesture performed by a user. For example, the electronic device 480 may display, on the screen 1310, an object 1313 to guide reducing the intensity of the user's gesture, based on at least one value related to the user's gesture exceeding the threshold range. For example, the electronic device 480 may display, on the screen 1310, an object 1313 to guide increasing the intensity of the user's gesture, based on at least one value related to the user's gesture below the threshold range.

The number of sensitivity levels that may be changed through the object 1313 may be changed according to an embodiment. For example, the object 1313 may be displayed to set sensitivity levels to one of ‘high’, ‘medium’, and ‘low’. For example, the object 1313 may be displayed to set sensitivity levels to one of 1 to 10.

According to an embodiment, the electronic device 480 may display, on the screen 1310, an object 1316 for providing a tutorial (e.g., tutorial image) for a reference gesture to a user. According to an embodiment, the electronic device 480 may provide a tutorial on a reference gesture performed using a part of a body on which the wearable device 400 is worn. For example, the electronic device 480 may be provided by another wearable device (e.g., smart watch device) worn with the wearable device 400 (e.g., smart ring device).

According to an embodiment, the electronic device 480 may provide a function for performing practice on a reference gesture while the screen 1310 is displayed. The electronic device 480 may provide a function for changing the sensitivity according to a practice result for the reference gesture through the screen 1310.

According to an embodiment, the electronic device 480 may provide a function for changing sensitivity for each of a plurality of gestures. For example, the electronic device 480 may provide a tutorial for a plurality of gestures. As an example, the electronic device 480 may guide performing a plurality of gestures through the screen 1310 (or user interface). As an example, the electronic device 480 may provide a tutorial for a first gesture and provide a function for changing sensitivity for the first gesture. After the sensitivity for the first gesture is changed, the electronic device 480 may provide a tutorial for a second gesture and provide a function for changing sensitivity for the second gesture.

According to an embodiment, the sensitivity of the wearable device 400 may be set at runtime. For example, the sensitivity (or threshold range) of the wearable device 400 may be set to ‘normal’. The electronic device 480 may display a screen 1310 for changing the sensitivity of the wearable device 400.

According to an embodiment, the electronic device 480 may provide the user with a notification for suggesting the user to change the sensitivity of the wearable device 400. The electronic device 480 may display the screen 1310 based on an input with respect to the notification. For example, when a gesture is identified through the wearable device 400, the electronic device 480 may provide a notification asking whether there is a malfunction. The electronic device 480 may identify a frequency of malfunction according to the user's response to the notification asking whether there is a malfunction. The electronic device 480 may provide a notification for suggesting to change the sensitivity of the wearable device 400, according to a frequency of malfunction. The electronic device 480 may display the screen 1310 based on an input with respect to the notification.

When the gesture is identified, the electronic device 480 may provide a notification asking whether there is a malfunction and identify the number of times that the malfunction has occurred. The electronic device 480 may obtain statistical information on the number of times that the malfunction has occurred. The electronic device 480 may provide a notification for suggesting to change the sensitivity of the wearable device 400, based on the statistical information on the number of times that a malfunction has occurred. The electronic device 480 may display the screen 1310 based on an input with respect to the notification.

For example, in case that a gesture is not recognized even though the user performed the gesture due to the low sensitivity of the wearable device 400, the electronic device 480 may provide a notification asking whether there is miss detection, and may identify the number of times that the miss detection has occurred. The electronic device 480 may obtain statistical information on the number of times that the miss detection has occurred. The electronic device 480 may provide a notification for suggesting to change the sensitivity of the wearable device 400, based on the statistical information on the number of times that the miss detection has occurred. The electronic device 480 may display the screen 1310 based on an input with respect to the notification.

According to an embodiment, the electronic device 480 may provide a function for changing sensitivity to each of a plurality of gestures. For example, sensitivity (or a threshold value, a threshold range) for each of the plurality of gestures may be set. As an example, the electronic device 480 may provide a menu for changing the sensitivity to each of the plurality of gestures. The electronic device 480 may display a screen (e.g., the screen 1310) for changing the sensitivity to the first gesture based on the menu. The electronic device 480 may display another screen for changing the sensitivity to the second gesture based on the menu.

For example, the electronic device 480 may guide the user to perform a reference gesture (or one of the plurality of gestures) and obtain at least one value related to a gesture performed by the user. Feedback may be provided based on whether the at least one value is out of a threshold range. The feedback may correspond to the object 1313. The electronic device 480 may provide feedback whenever the user performs a corresponding gesture. For example, the object 1313 may be displayed based on a toast pop-up. The object 1313 may be displayed as overlapping on at least a portion of objects (or background) displayed on the screen 1310. Since feedback on a gesture performed by the user is provided in the electronic device 480, the user may adjust the intensity of the gesture by themselves based on the provided feedback.

According to an embodiment, after the gesture is repeatedly performed by the user, the electronic device 480 may display, on the screen 1310, information for suggesting to change (or maintain) the sensitivity. In addition, the electronic device 480 may display an object 1315 for changing the sensitivity. The user may change the sensitivity by using the object 1315, based on information for suggesting to change (or maintain) the sensitivity.

For example, when the wearable device 400 is worn on a finger, energy identified according to users may be different. For example, energy (or acceleration-related energy) identified by the wearable device 400 may be different according to the amount of muscle of the user, motor nerve, a position of the wearing finger, and/or whether a hand on which the wearable device 400 is worn is a dominant hand. Accordingly, the electronic device 480 may provide a function (or screen) for changing the sensitivity of the wearable device 400. As the sensitivity of the wearable device 400 is changed, a threshold value for signal segmentation may be changed. The electronic device 480 may improve the accuracy of the signal segmentation operation based on changing the threshold value of the signal segmentation operation performed in the wearable device 400. Therefore, a false detection probability of the gesture may be reduced.

According to an embodiment, the wearable device 400 may be worn on a wrist. The wearable device 400 may include a smart watch device. The wearable device 400 may obtain one or more feature points for movement (or gesture) of the hand, finger, and/or arm, and provide feedback on the movement (or gesture) of the hand, finger, and arm. The wearable device 400 may segment a gesture performed through a hand (or a finger) having a small range of movement and a gesture performed through an arm having a large range of movement. The wearable device 400 may provide feedback on each of the gesture performed through a hand (or a finger) and the gesture performed through an arm.

For example, the wearable device 400 worn on the wrist may identify a gesture of shaking the arm and/or a gesture of moving the arm back and forth. The wearable device 400 may provide feedback of a direction with respect to movement with respect to a gesture having large movement such as the gestures. According to an embodiment, the electronic device 480 may display a user interface so that the user may change the accuracy with respect to a direction of the user's movement. For example, in case that the accuracy of the movement direction is set high, the wearable device 400 may identify that the user has performed a gesture only when the user performs the gesture in a correct direction. Accordingly, false detection (or malfunction) may be reduced. For example, in case that the accuracy of the motion direction is set low, the wearable device 400 may identify that the user has performed the gesture even when the user does not perform the gesture in the correct direction. Accordingly, usability may be increased. Since the user of the electronic device 480 (or the wearable device 400) may determine the accuracy of the movement direction, user convenience may be increased.

According to an embodiment, the electronic device 480 may provide various feedback on a gesture performed by the user. For example, the electronic device 480 may provide feedback on features of the gesture identified by the electronic device 480 as well as the intensity (or speed) of the gesture performed by the user.

For example, for a double pinch gesture in which the thumb and index finger are in contact twice in succession, the electronic device 480 may obtain feature information including a distance between peaks of the signal according to the double pinch gesture and/or the autocorrelation coefficient of the signal. The electronic device 480 may provide a user with feedback on a speed of the gesture, based on the feature information. For example, the electronic device 480 may display a screen (or user interface) for providing feedback so that the user may directly adjust the speed. According to an embodiment, a model (or classifier) for providing an input according to a first speed and a model (or classifier) for providing an input according to a second speed slower than the first speed may be configured in the electronic device 480 (or the wearable device 400) for distinguishing between the pinch gesture and the double pinch gesture.

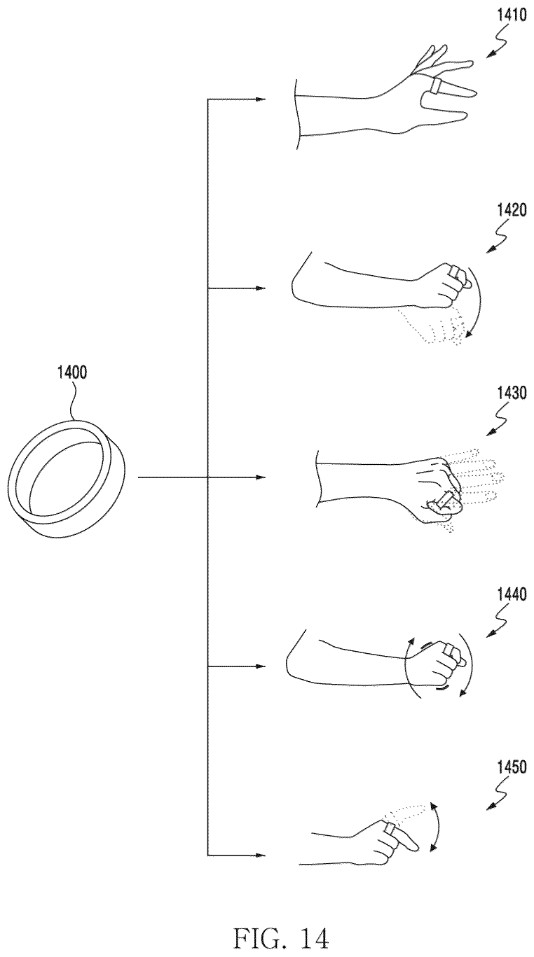

FIG. 14 illustrates an example of gestures identified through a smart ring device according to an embodiment.

Referring to FIG. 14, a smart ring device 1400 may be an example of the wearable device 400 described above. The smart ring device 1400 may be worn on a user's finger (e.g., an index finger). The smart ring device 1400 may identify movement of a user's hand (or finger) and identify a gesture corresponding to the movement of the user's hand (or finger).

According to an embodiment, a function (or a function for an application) of the electronic device 480 may be mapped to each of a plurality of gestures. Hereinafter, an example of gestures capable of being identified in the smart ring device 1400 and an example of functions according to gestures will be described.

For example, the smart ring device 1400 may identify a gesture 1410. The smart ring device 1400 may identify a gesture 1410 in which the user's index finger and thumb contact each other. For example, the gesture 1410 may be referred to as a pinch gesture. For example, a gesture in which the gesture 1410 is performed twice in succession may be referred to as a double pinch gesture.

For example, the gesture 1410 may be used to control a watch application (or an alarm application). The electronic device 480 may identify that an alarm is generated in a watch application (or an alarm application). The electronic device 480 may activate a function related to a gesture classification operation of the wearable device 400 based on the occurrence of the alarm. Based on the gesture 1410 being performed twice in succession, an alarm release operation may be performed in the watch application (or alarm application) of the electronic device 480.

For example, the gesture 1410 may be used to control a camera application. The electronic device 480 may identify that the camera application is executed. The electronic device 480 may activate a function related to a gesture classification operation of the wearable device 400 based on execution of the camera application. Based on the gesture 1410 being performed twice in succession, a photographing start (or stop) operation may be performed in the camera application.

For example, the smart ring device 1400 may identify a gesture 1420. The smart ring device 1400 may identify the gesture 1420 in which a first moves up and down. For example, the gesture 1420 may be referred to as a knock gesture. For example, a gesture in which the gesture 1420 is performed twice in succession may be referred to as a double knock gesture (or knock-knock gesture). For example, the gesture 1420 may be used for quick execution of an application of the electronic device 480. Based on the gesture 1420 being performed twice in succession, an application specified by the user may be executed.

For example, the smart ring device 1400 may identify a gesture 1430. The smart ring device 1400 may identify a gesture 1430 of clenching and opening a fist. For example, the gesture 1430 may be referred to as an open-clench-open (OCO) gesture. For example, a gesture in which the gesture 1430 is performed twice in succession may be referred to as a double OCO gesture (or OCO2 gesture).

For example, the gesture 1430 may be used to control a phone application. Based on the gesture 1430 being performed, a function for answering or rejecting a call may be performed.

For example, the smart ring device 1400 may identify a gesture 1440. The smart ring device 1400 may identify the gesture 1440 of shaking a first from side to side. For example, a gesture 1440 may be referred to as a node gesture. For example, the gesture 1440 may be used for switching applications. Based on the gesture 1440 being performed, one of applications executed in the background may be displayed.

For example, the smart ring device 1400 may identify a gesture 1450. The smart ring device 1400 may identify a gesture 1450 that moves only a finger on which the smart ring device 1400 is worn. For example, the gesture 1450 may be referred to as a swipe gesture. According to an embodiment, the gesture 1450 may be performed as an operation of tapping an object. For example, the gesture 1450 may be used for an e-book application. Based on the gesture 1450 being performed, an operation of turning a page of an e-book may be performed.

The operations according to the above-described gestures 1410 to 1450 are exemplary but are not limited thereto. Various operations may be mapped to the gesture 1410 to the gesture 1450. The smart ring device 1400 may identify various gestures as well as the gestures 1410 to 1450.

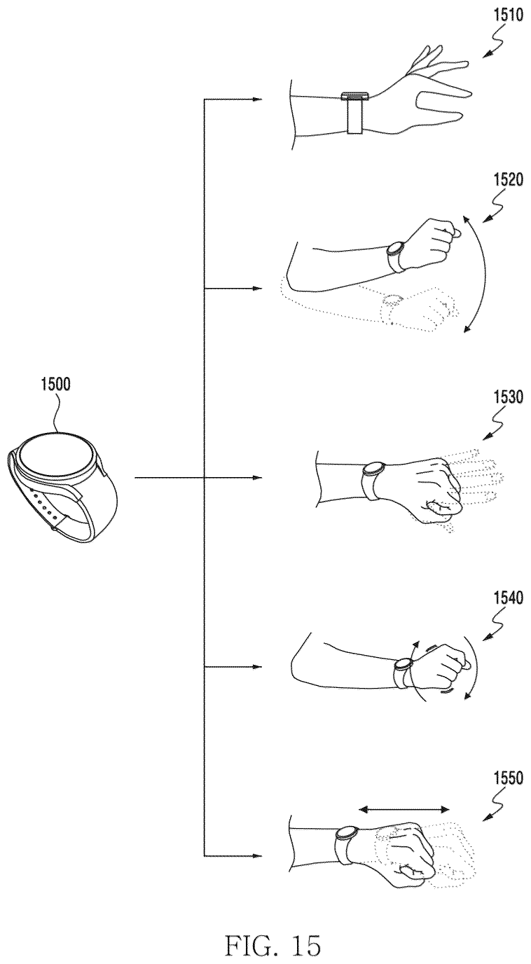

FIG. 15 illustrates an example of gestures identified through a smart watch device according to an embodiment.

Referring to FIG. 15, a smart watch device 1500 may be an example of the above-described wearable device 400. The smart watch device 1500 may be worn on a user's wrist. The smart watch device 1500 may identify movement of a user's hand, finger, or arm, and identify a gesture corresponding to the movement.

According to an embodiment, a function (or a function for an application) of the electronic device 480 may be mapped to each of a plurality of gestures. Hereinafter, an example of gestures capable of being identified in the smart watch device 1500 and an example of a function according to a gesture will be described.

For example, the smart watch device 1500 may identify a gesture 1510. The smart watch device 1500 may identify the gesture 1510 in which the user's index finger and thumb contact each other. For example, the gesture 1510 may be referred to as a pinch gesture. For example, a gesture in which the gesture 1510 is performed twice in succession may be referred to as a double pinch gesture.

For example, the gesture 1510 may be used to control a phone application. Based on the gesture 1510 being performed twice in succession, a call receiving function (or a call hanging function) may be performed.

For example, the gesture 1510 may be used to control a media playback application. Based on the gesture 1510 being performed twice in succession, a playback function (or pause function) may be performed.

For example, the gesture 1510 may be used to control a stopwatch application. Based on the gesture 1510 being performed twice in succession, a pause function (or a resume function) of a stopwatch may be performed.

For example, the gesture 1510 may be used to control the smart watch device 1500. Based on the gesture 1510 being performed twice in succession, a click function of an icon activated on a watch face may be performed.

For example, the gesture 1510 may be used to control the smart watch device 1500. Based on the gesture 1510 being performed twice in succession, a scroll function (or a function of replying to a notification) according to the notification reception may be performed in the watch face.

For example, the smart watch device 1500 may identify a gesture 1520. The smart watch device 1500 may identify a gesture 1520 that moves an arm up and down. For example, the gesture 1520 may be referred to as a node gesture. For example, a gesture in which the gesture 1520 is performed twice in succession may be referred to as a double node gesture. For example, the gesture 1520 may be used to execute an application of the electronic device 480. Based on the gesture 1520 being performed twice in succession, an execution function of the selected application may be performed. The smart watch device 1500 may identify a gesture (e.g., the gesture 1420 of FIG. 14) of moving the wrist up and down. For example, the gesture of moving the wrist up and down may be referred to as a knock gesture.

For example, the smart watch device 1500 may identify a gesture 1530. The smart watch device 1500 may identify a gesture 1530 of clenching and opening a fist. For example, the gesture 1530 may be referred to as an open-clench-open (OCO) gesture. For example, the gesture 1530 may be used to enter an action menu of the smart watch device 1500. Based on the gesture 1530 being performed twice in succession, the action menu of the smart watch device 1500 may be displayed.

For example, the smart watch device 1500 may identify a gesture 1540. The smart watch device 1500 may identify the gesture 1540 of shaking a first from side to side. For example, the gesture 1540 may be referred to as a shake gesture. For example, the gesture 1540 may be used for a phone application. Based on the gesture 1540 being performed, a call rejection function may be performed.

For example, the smart watch device 1500 may identify the gesture 1550. The smart watch device 1500 may identify the gesture 1550 of moving the arm on which the smart watch device 1500 is worn back and forth. For example, the gesture 1550 may be referred to as an in-out gesture. For example, the gesture 1550 may be used for a function of moving to a previous screen. Based on the gesture 1550 being performed, a screen of the electronic device 480 or the smart watch device 1500 may be changed to a previously displayed screen.

The operations according to the above-described gestures 1510 to 1550 are exemplary and are not limited thereto. The smart watch device 1500 may identify various gestures as well as the gestures 1510 to 1550. Various operations may be mapped to the gestures 1510 to 1550. For example, based on performing the gesture 1510 once, a function for switching to the next item may be performed. Based on the gesture 1510 being performed twice, a function for switching to a previous item may be performed. Based on the gesture 1530 being performed once, an input function may be performed. Based on the gesture 1530 being performed twice, an action menu display function may be performed. Based on the gesture 1550 being performed, a function of moving to a previous screen may be performed.

According to an embodiment, a gesture corresponding to a voice recognition application execution function, a scan method change function, and/or a watch screen display function may be set.

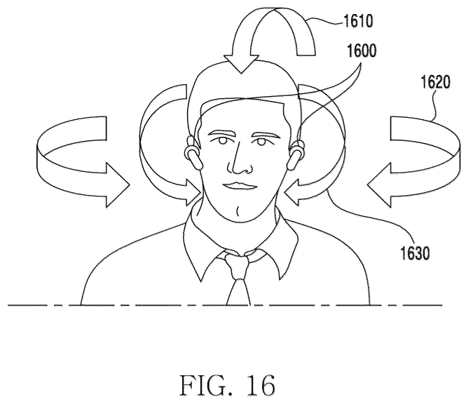

FIG. 16 illustrates an example of gestures identified through a true wireless stereo (TWS) device according to an embodiment.

Referring to FIG. 16, the TWS device 1600 may be an example of the wearable device 400 described above. The TWS device 1600 may be worn on the ear. The TWS device 1600 may be at least partially accommodated within the user's ear. FIG. 16 illustrates the TWS device 1600 in a form of an earbud, but is not limited thereto. The TWS device 1600 may include an open wireless stereo (OWS) device, a headset (e.g., an over-ear type headset or an on-ear type headset), and/or a head-mounted device (HMD).

According to an embodiment, a function of the electronic device 480 (or a function for an application) may be mapped to each of a plurality of gestures. Hereinafter, an example of gestures capable of being identified in the TWS device 1600 and an example of a function according to a gesture will be described.

For example, the TWS device 1600 may identify a gesture 1610. The TWS device 1600 may identify the gesture 1610 that nods the user's head. For example, the gesture 1610 may be referred to as a node gesture. For example, the gesture 1610 may be used for a phone application. Based on the gesture 1610 being performed, a call receiving function may be performed. For example, the gesture 1610 may be used for an artificial intelligence application. Based on the gesture 1610 being performed, a response (e.g., “YES”) to a query of an artificial intelligence application may be performed.

For example, the TWS device 1600 may identify a gesture 1620. The TWS device 1600 may identify the gesture 1620 that shakes the user's head from side to side. For example, the gesture 1620 may be referred to as a shake gesture. For example, the gesture 1620 may be used for a phone application. Based on the gesture 1620 being performed, a call rejection function may be performed. For example, the gesture 1620 may be used for an artificial intelligence application. Based on the gesture 1620 being performed, a response (e.g., “NO”) to a query of an artificial intelligence application may be performed. For example, the gesture 1620 may be used for a watch application (or an alarm application). Based on the gesture 1620 being performed, an alarm turn-off function may be performed.

For example, the TWS device 1600 may identify a gesture 1630. The TWS device 1600 may identify the gesture 1630 of tilting the user's head left and right. For example, the gesture 1630 may be referred to as a tilt gesture. For example, the gesture 1630 may be used for an artificial intelligence application. Based on the gesture 1630 being performed, a response (e.g., “YES”) to a query of an artificial intelligence application may be performed.

The TWS device 1600 may identify a gesture with respect to a touch input to the TWS device 1600. The TWS device 1600 may include a first device worn on a left ear and a second device worn on a right ear. The TWS device 1600 may identify a touch input for one of the first device and the second device.

According to an embodiment, various functions may be mapped to gestures described in FIGS. 14 to 16. For example, in a watch application, an alarm interruption function may be performed based on a first gesture, and a snooze function may be performed based on a second gesture. For example, in a media playback application, a playback function may be performed based on a first gesture, and a pause function may be performed based on a second gesture. For example, in a photography mode of a camera application, a shutter function may be performed based on a first gesture. In a video shooting mode of the camera application, a recording start function may be performed based on a first gesture, and a recording stop function may be performed based on a second gesture. For example, in a watch application, a time notification function may be performed based on a first gesture when waking up briefly during sleep. For example, in a phone application, a call receiving function may be performed based on a first gesture, a call rejection function may be performed based on a second gesture, and a mute function may be performed based on a third gesture.

According to an embodiment, the gestures described in FIGS. 14 to 16 may be variously changed according to a country and/or a culture, and a function according to gestures may be mapped by a user.

According to an embodiment, an electronic device may comprise a display, communication circuitry, memory storing instructions, comprising one or more storage media, and at least one processor comprising processing circuitry. The instructions, when executed by the at least one processor individually or collectively, may cause the electronic device to display, via the display, a screen for guiding performance of a reference gesture via a part of body of a user on which a wearable device connected to the electronic device is worn. The instructions, when executed by the at least one processor individually or collectively, may cause the electronic device to, while the screen is displayed, identify that at least one value related to a gesture of the user, obtained via the wearable device, is out of a threshold range related to the reference gesture. The instructions, when executed by the at least one processor individually or collectively, may cause the electronic device to, based on identifying that the at least one value related to the gesture of the user is out of the threshold range, display, via the display, a visual object for guiding to change the threshold range. The instructions, when executed by the at least one processor individually or collectively, may cause the electronic device to, according to an input related to the visual object, change the threshold range.

According to an embodiment, the instructions, when executed by the at least one processor individually or collectively, may cause the electronic device to identify, via the wearable device, the at least one value related to the gesture of the user. The instructions, when executed by the at least one processor individually or collectively, may cause the electronic device to, based on the at least one value related to the gesture of the user, display, via the display, an object for providing feedback on intensity of the gesture of the user on the screen.

According to an embodiment, the instructions, when executed by the at least one processor individually or collectively, may cause the electronic device to display, based on the at least one value related to the gesture of the user greater than the threshold range, the object for guiding to reduce the intensity of the gesture of the user on the screen via the display.

According to an embodiment, the instructions, when executed by the at least one processor individually or collectively, may cause the electronic device to display, based on the at least one value related to the gesture of the user less than the threshold range, the object for guiding to increase the intensity of the gesture of the user on the screen via the display.

According to an embodiment, the intensity of the gesture may be identified based on a range at which the part of the body moves to perform the gesture, velocity, or strength.

According to an embodiment, the instructions, when executed by the at least one processor individually or collectively, may cause the electronic device to, based on changing the threshold range according to the input related to the visual object, transmit, to the wearable device, information on the changed threshold range. The information on the changed threshold range may cause the wearable device to update a threshold range set in the wearable device to the changed threshold range.

According to an embodiment, the screen may include a user interface of an application for managing settings related to a gesture of the user.

According to an embodiment, the visual object may include a slider to change the threshold range.

According to an embodiment, the instructions, when executed by the at least one processor individually or collectively, may cause the electronic device to, based on an execution of an application controllable according to a gesture of the user, receive, from the wearable device, information indicating that one gesture among a plurality of gestures is performed while the application is being executed. The instructions, when executed by the at least one processor individually or collectively, may cause the electronic device to, while the application is being executed, based on the information indicating that one gesture among the plurality of gestures is performed, perform a function related to the application corresponding to one gesture of the plurality of gestures.

According to an embodiment, the instructions, when executed by the at least one processor individually or collectively, may cause the electronic device to, based on the execution of the application, transmit, to the wearable device, a first signal for causing the wearable device to activate a function to identify one gesture among the plurality of gestures. The instructions, when executed by the at least one processor individually or collectively, may cause the electronic device to, based interruption of the execution of the application, transmit, to the wearable device, a second signal for causing the wearable device to deactivate the function to identify one gesture among the plurality of gestures.

According to an embodiment, the threshold range may be set based on a threshold value for identifying the gesture as the reference gesture. The instructions, when executed by the at least one processor individually or collectively, may cause the electronic device to change the threshold value based on changing the threshold range.

According to an embodiment, a method performed by an electronic device may comprise displaying, via a display of the electronic device, a screen for guiding performance of a reference gesture via a part of body of a user on which a wearable device connected to the electronic device is worn. The method may comprise, while the screen is displayed, identifying that at least one value related to a gesture of the user, obtained via the wearable device, is out of a threshold range related to the reference gesture. The method may comprise, based on identifying that the at least one value related to the gesture of the user is out of the threshold range, displaying, via the display, a visual object for guiding to change the threshold range. The method may comprise, according to an input related to the visual object, changing the threshold range.

According to an embodiment, the method may comprise identifying, via the wearable device, the at least one value related to the gesture of the user. The method may comprise, based on the at least one value related to the gesture of the user, displaying, via the display, an object for providing feedback on intensity of the gesture of the user on the screen.

According to an embodiment, the method may comprise displaying, based on the at least one value related to the gesture of the user greater than the threshold range, the object for guiding to reduce the intensity of the gesture of the user on the screen via the display.

According to an embodiment, the method may comprise displaying, based on the at least one value related to the gesture of the user less than the threshold range, the object for guiding to increase the intensity of the gesture of the user on the screen via the display.

According to an embodiment, the intensity of the gesture may be identified based on a range at which the part of the body moves to perform the gesture, velocity, or strength.

According to an embodiment, the method may comprise, based on changing the threshold range according to the input related to the visual object, transmitting, to the wearable device, information on the changed threshold range. The information on the changed threshold range may cause the wearable device to update a threshold range set in the wearable device to the changed threshold range.

According to an embodiment, the screen may include a user interface of an application for managing settings related to a gesture of the user.

According to an embodiment, the method may comprise, based on an execution of an application controllable according to a gesture of the user, receiving, from the wearable device, information indicating that one gesture among a plurality of gestures is performed while the application is being executed. The method may comprise, while the application is being executed, based on the information indicating that one gesture among the plurality of gestures is performed, performing a function related to the application corresponding to one gesture of the plurality of gestures.

According to an embodiment, a non-transitory computer readable storage medium may store one or more programs. The one or more programs may include instructions which, when executed by at least one processor of an electronic device with a display and communication circuitry, cause the electronic device to display, via the display, a screen for guiding performance of a reference gesture via a part of body of a user on which a wearable device connected to the electronic device is worn. The one or more programs may include instructions which, when executed by the at least one processor, cause the electronic device to, while the screen is displayed, identify that at least one value related to a gesture of the user, obtained via the wearable device, is out of a threshold range related to the reference gesture. The one or more programs may include instructions which, when executed by the at least one processor, cause the electronic device to, based on identifying that the at least one value related to the gesture of the user is out of the threshold range, display, via the display, a visual object for guiding to change the threshold range. The one or more programs may include instructions which, when executed by the at least one processor, cause the electronic device to, according to an input related to the visual object, change the threshold range.

According to an embodiment, a smart ring device may comprise at least one sensor for identifying movement of the smart ring device, communication circuitry, memory storing instructions, comprising one or more storage media, and at least one processor comprising processing circuitry. The instructions, when executed by the at least one processor individually or collectively, may cause the smart ring device to obtain, using the at least one sensor, first data related to movement of a part of a body of a user on which the smart ring device is worn in a first time interval. The instructions, when executed by the at least one processor individually or collectively, may cause the smart ring device to identify a second time interval related to at least one value greater than a threshold value among values identified based on the first data in the first time interval. The instructions, when executed by the at least one processor individually or collectively, may cause the smart ring device to identify second data corresponding to the second time interval of the first data. The instructions, when executed by the at least one processor individually or collectively, may cause the smart ring device to set one or more feature points identified based on the second data as an input of a model for identifying a gesture of the user. The instructions, when executed by the at least one processor individually or collectively, may cause the smart ring device to determine, based on an output of the model, a gesture corresponding to the movement of the part of the body, among a plurality of gestures. The instructions, when executed by the at least one processor individually or collectively, may cause the smart ring device to transmit, via the communication circuitry, information indicating the determined gesture to an electronic device connected with the smart ring device.

According to an embodiment, the instructions, when executed by the at least one processor individually or collectively, may cause the smart ring device to obtain sensing data using the at least one sensor. The instructions, when executed by the at least one processor individually or collectively, may cause the smart ring device to obtain the first data having a reference frequency among the sensing data.

According to an embodiment, the model may be configured based on a plurality of decision trees. The plurality of decision trees may correspond to the plurality of gestures respectively. The instructions, when executed by the at least one processor individually or collectively, may cause the smart ring device to, based on identifying that a probability value according to a decision tree corresponding the gesture among the plurality of decision trees is the highest, determine the gesture corresponding to the movement of the part of the body.

According to an embodiment, a method performed by a smart ring device may comprise obtaining, using at least one sensor of the smart ring device, first data related to movement of a part of a body of a user on which the smart ring device is worn in a first time interval. The method may comprise identifying a second time interval related to at least one value greater than a threshold value among values identified based on the first data in the first time interval. The method may comprise identifying second data corresponding to the second time interval of the first data. The method may comprise setting one or more feature points identified based on the second data as an input of a model for identifying a gesture of the user.

The method may comprise determining, based on an output of the model, a gesture corresponding to the movement of the part of the body, among a plurality of gestures. The method may comprise transmitting, via a communication circuitry of the smart ring device, information indicating the determined gesture to an electronic device connected with the smart ring device.

According to an embodiment, the method may comprise obtaining sensing data using the at least one sensor. The method may comprise obtaining the first data having a reference frequency among the sensing data.

According to an embodiment, the model may be configured based on a plurality of decision trees. The plurality of decision trees may correspond to the plurality of gestures respectively. The method may comprise, based on identifying that a probability value according to a decision tree corresponding the gesture among the plurality of decision trees is the highest, determining the gesture corresponding to the movement of the part of the body.

According to an embodiment, a non-transitory computer readable storage medium may store one or more programs. The one or more programs may include instructions which, when executed by at least one processor of a smart ring device with at least one sensor and communication circuitry, cause the electronic device to obtain, using the at least one sensor, first data related to movement of a part of a body of a user on which the smart ring device is worn in a first time interval. The one or more programs may include instructions which, when executed by the at least one processor, cause the electronic device to identify a second time interval related to at least one value greater than a threshold value among values identified based on the first data in the first time interval. The one or more programs may include instructions which, when executed by the at least one processor, cause the electronic device to identify second data corresponding to the second time interval of the first data. The one or more programs may include instructions which, when executed by the at least one processor, cause the electronic device to set one or more feature points identified based on the second data as an input of a model for identifying a gesture of the user. The one or more programs may include instructions which, when executed by the at least one processor, cause the electronic device to determine, based on an output of the model, a gesture corresponding to the movement of the part of the body, among a plurality of gestures. The one or more programs may include instructions which, when executed by the at least one processor, cause the electronic device to transmit, via the communication circuitry, information indicating the determined gesture to an electronic device connected with the smart ring device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display;
communication circuitry;
memory storing instructions, comprising one or more storage media; and
at least one processor comprising processing circuitry,
wherein the instructions, when executed by the at least one processor individually or collectively, cause the electronic device to:
display, via the display, a screen configured to guide performance of a reference gesture via a part of a body of a user on which a wearable device connected to the electronic device is worn,
while the screen is displayed, identify that at least one value related to a gesture of the user is out of a threshold range related to the reference gesture, wherein the at least one value is obtained via the wearable device,
based on identifying that the at least one value is outside of the threshold range, display, via the display, a visual object configured to guide a change of the threshold range, and
based on an input related to the visual object, change the threshold range.

2. The electronic device of claim 1, wherein the instructions, when executed by the at least one processor individually or collectively, cause the electronic device to:
identify, via the wearable device, the at least one value, and
based on the at least one value, display, via the display, an object configured to provide feedback on an intensity of the gesture of the user on the screen.

3. The electronic device of claim 2, wherein the instructions, when executed by the at least one processor individually or collectively, cause the electronic device to display on the screen, based on the at least one value being greater than the threshold range, an object configured to guide a reduction of the intensity of the gesture of the user.

4. The electronic device of claim 2, wherein the instructions, when executed by the at least one processor individually or collectively, cause the electronic device to display on the screen, based on the at least one value being less than the threshold range, an object configured to guide an increase of the intensity of the gesture of the user.

5. The electronic device of claim 2, wherein the intensity of the gesture is identified based on one or more of a velocity of a part of the body that moves to perform the gesture, or a strength associated with the gesture.

6. The electronic device of claim 1,
wherein the instructions, when executed by the at least one processor individually or collectively, cause the electronic device to, based on changing the threshold range according to the input related to the visual object, transmit, to the wearable device, information on the changed threshold range, and
wherein the information on the changed threshold range is configured to cause the wearable device to update a threshold range set in the wearable device to the changed threshold range.

7. The electronic device of claim 1, wherein the screen comprises a user interface of an application configured to manage settings related to a gesture of the user.

8. The electronic device of claim 1, wherein the visual object comprises a slider to change the threshold range.

9. The electronic device of claim 1, wherein the instructions, when executed by the at least one processor individually or collectively, cause the electronic device to:
based on execution of an application controllable through a gesture of the user, receive, from the wearable device, information indicating that one gesture among a plurality of gestures is performed while the application is being executed, and
while the application is being executed, based on the information indicating that one gesture among the plurality of gestures is performed, perform a function related to the application corresponding to the one gesture of the plurality of gestures.

10. The electronic device of claim 9, wherein the instructions, when executed by the at least one processor individually or collectively, cause the electronic device to:
based on the execution of the application, transmit, to the wearable device, a first signal configured to cause the wearable device to activate a function to identify the one gesture among the plurality of gestures, and
based interruption of the execution of the application, transmit, to the wearable device, a second signal configured to cause the wearable device to deactivate the function to identify the one gesture among the plurality of gestures.

11. The electronic device of claim 1,
wherein the threshold range is set based on a threshold value for identifying the gesture as the reference gesture, and
wherein the instructions, when executed by the at least one processor individually or collectively, cause the electronic device to change the threshold value based on changing the threshold range.

12. A method performed by an electronic device, the method comprising:
displaying, via a display of the electronic device, a screen configured to guide performance of a reference gesture via a part of a body of a user on which a wearable device connected to the electronic device is worn,
while the screen is displayed, identifying that at least one value related to a gesture of the user, is out of a threshold range related to the reference gesture, wherein the at least one value is obtained via the wearable device;
based on identifying that the at least one value is outside of the threshold range, displaying, via the display, a visual object configured to guide a change of the threshold range; and
based on an input related to the visual object, changing the threshold range.

13. The method of claim 12, further comprising:
identifying, via the wearable device, the at least one value; and
based on the at least one value, displaying, via the display, an object configured to provide feedback on an intensity of the gesture of the user on the screen.

14. The method of claim 13, further comprising:
displaying on the screen, based on the at least one value being greater than the threshold range, an object configured to guide a reduction of the intensity of the gesture of the user.

15. The method of claim 13, further comprising:
displaying on the screen, based on the at least one value being less than the threshold range, an object configured to guide an increase of the intensity of the gesture of the user.

16. The method of claim 13, wherein the intensity of the gesture is identified based on one or more of a velocity of a part of the body that moves to perform the gesture, or a strength associated with the gesture.

17. The method of claim 12, further comprising:
based on changing the threshold range according to the input related to the visual object, transmitting, to the wearable device, information on the changed threshold range,
wherein the information on the changed threshold range is configured to cause the wearable device to update a threshold range set in the wearable device to the changed threshold range.

18. The method of claim 12, wherein the screen comprises a user interface of an application configured to manage settings related to a gesture of the user.

19. The method of claim 12, further comprising:
based on execution of an application controllable through a gesture of the user, receiving, from the wearable device, information indicating that one gesture among a plurality of gestures is performed while the application is being executed, and
while the application is being executed, based on the information indicating that one gesture among the plurality of gestures is performed, performing a function related to the application corresponding to the one gesture of the plurality of gestures.

20. A non-transitory computer readable storage medium storing one or more programs, wherein the one or more programs include instructions, when executed by at least one processor of an electronic device with a display and communication circuitry, cause the electronic device to:
display, via a display of the electronic device, a screen configured to guide performance of a reference gesture via a part of a body of a user on which a wearable device connected to the electronic device is worn,
while the screen is displayed, identify that at least one value related to a gesture of the user, is out of a threshold range related to the reference gesture, wherein the at least one value is obtained via the wearable device;
based on identifying that the at least one value is outside of the threshold range, display, via the display, a visual object configured to guide a change of the threshold range; and
based on an input related to the visual object, changing the threshold range.
